(19) United States
(12) Patent Application Publication
(10) Pub. No.: US 2026/0351625 A1
(43) Pub. Date: Nov. 5, 2026

(54) ELECTRODE-SOLID ELECTROLYTE ASSEMBLY, SOLID OXIDE CELL INCLUDING THE SAME, AND METHOD OF PREPARING THE SAME

(71) Applicant: Samsung Electronics Co., Ltd, Suwon-si (KR)

(72) Inventors: Jusik Kim, Suwon-si (KR); Jihwan Song, Suwon-si (KR); Seungbok Lee, Suwon-si (KR); Junghwan Kim, Suwon-si (KR); Doh Won Jung, Suwon-si (KR); SANG MIN JI, Suwon-si (KR)

(21) Appl. No.: 19/442,488

(22) Filed: Jan. 7, 2026

(30) Foreign Application Priority Data
May 2, 2025 (KR) 10-2025-0058490

(51) Int. Cl. H01M 4/90; C01G 51/70; C25B 9/23; C25B 13/07; H01M 4/86; H01M 4/88; H01M 8/12; H01M 8/1213; H01M 8/1253

(52) U.S. Cl. CPC H01M 4/9033; C01G 51/70; C25B 9/23; C25B 13/07; H01M 4/8621; H01M 4/8642; H01M 4/8657; H01M 4/8889; H01M 8/1213; H01M 8/1253; C01P 2002/34; C01P 2002/50; C01P 2002/72; C01P 2002/77; C01P 2002/85; C01P 2004/03; C01P 2004/04; C01P 2006/40; H01M 2004/8689; H01M 2008/1293

(57) ABSTRACT

An electrode-solid electrolyte assembly including an electrode and a solid electrolyte layer, a solid oxide cell including the assembly, and a method of preparing the assembly. The electrode-solid electrolyte assembly includes a first electrode layer including a first solid ion conductor, and a second electrode layer disposed between the first electrode layer and the solid electrolyte layer, and including the first solid ion conductor and a second solid ion conductor. The first solid ion conductor includes a metal oxide having a perovskite-type structure, the metal oxide includes a first element and a second element that occupy cuboctahedral sites of the perovskite-type structure, and the first element and the second element are each independently an element belonging to Group 2 of the periodic table and having an atomic weight of 30 or more. The second electrode layer either has a content gradient in which a content of the second solid ion conductor transitions from a first content in a first region to a second content in a second region, and the second content is greater than the first content, or the second electrode layer has a first content that is essentially constant within the layer.

### CROSS-REFERENCE TO RELATED APPLICATION

This application claims priority to Korean Patent Application No. 10-2025-0058490, filed on May 2, 2025, in the Korean Intellectual Property Office, and all the benefits accruing therefrom under 35 U.S.C. § 119, the disclosure of which in its entirety is incorporated by reference herein.

### BACKGROUND

### 1. Field

The disclosure relates to an electrode-solid electrolyte assembly, a solid oxide cell including the electrode-solid electrolyte assembly, and a method of preparing the electrode-solid electrolyte assembly.

### 2. Description of the Related Art

Solid oxide cells can operate in a fuel-cell mode in which fuel is oxidized and air is reduced to generate electricity. Solid oxide cells can also operate in an electrolysis-cell mode in which water is electrolyzed to produce hydrogen. However, during operation of the solid oxide cell in the electrolysis-cell mode, degradation of an electrode of the solid oxide cell may occur. Accordingly, there is ongoing interest to develop solid oxide cells with improved operating performance.

### SUMMARY

Provided is a novel electrode-solid electrolyte assembly having improved structural stability and electrolysis performance.

Provided is a solid oxide cell including the electrode-solid electrolyte assembly.

Provided is a method of preparing the electrode-solid electrolyte assembly.

Additional aspects will be set forth in part in the description which follows and, in part, will be apparent from the description, or may be learned by practice of the presented embodiments of the disclosure.

According to an aspect of the disclosure, an electrode-solid electrolyte assembly includes an electrode and a solid electrolyte layer, wherein the electrode includes:
a first electrode layer including a first solid ion conductor; and
a second electrode layer disposed between the first electrode layer and a surface of the solid electrolyte layer, and including the first solid ion conductor and a second solid ion conductor,
wherein the first solid ion conductor may include a metal oxide having a perovskite-type structure comprising a first element and a second element that occupy cuboctahedral sites of the perovskite-type structure, and the first element and the second element are each independently an element belonging to Group 2 of the periodic table and having an atomic weight of 30 or more, and
wherein the second electrode layer has a content gradient that transitions from a first content of the second solid ion conductor in a first region adjacent to the first electrode layer to a second content in a second region adjacent to the solid electrolyte layer, and the second content is greater than the first content; or
the first content of the second solid ion conductor is essentially constant from the first region to the second region of the second electrode layer.

According to another aspect of the disclosure, a solid oxide cell includes
the electrode-solid electrolyte assembly described herein, and
a fuel electrode disposed on an opposite surface of the solid electrolyte layer of the assembly,
wherein the electrode of the assembly is an air electrode.

According to another aspect of the disclosure, a method of preparing an electrode-solid electrolyte assembly includes:
providing a solid electrolyte layer;
providing a second electrode layer precursor containing a first solid ion conductor on a surface of the solid electrolyte layer;
infiltrating the second electrode layer precursor with a composition including second solid ion conductor particles and a solvent to provide a second electrode layer precursor including the second solid ion conductor particles;
heat-treating the second electrode layer precursor including the second solid ion conductor particles to provide a second electrode layer; and
positioning a first electrode layer on the second electrode layer to provide the electrode-solid electrolyte assembly,
wherein the second electrode layer has a content gradient in which the content of the second solid ion conductor transitions from a first content in a first region adjacent to the first electrode layer to a second content in a second region adjacent to the solid electrolyte layer, and the second content is greater than the first content, or
the first content of the second solid ion conductor is essentially constant from the first region to the second region of the second electrode layer,
wherein the first solid ion conductor includes a metal oxide having a perovskite-type structure comprising a first element and a second element that occupy cuboctahedral sites of the perovskite-type structure, and the first element and the second element are each independently an element belonging to Group 2 of the periodic table and having an atomic weight of 30 or more.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a schematic cross-sectional view of an electrode-solid electrolyte assembly according to an embodiment;

FIGS. 2A to 2C are graphs showing a content gradient of a second solid ion conductor along a thickness direction of a second electrode layer in an electrode-solid electrolyte assembly according to an embodiment;

FIG. 2D is a graph showing that a second solid ion conductor has a uniform content along a thickness direction of a second electrode layer in an electrode-solid electrolyte assembly according to an embodiment;

FIG. 3A is a schematic representation of a cross-section of a second electrode layer of a solid oxide cell according to an embodiment;

FIG. 3B is a schematic representation of a cross-section of a second electrode layer of a solid oxide cell according to another embodiment;

FIG. 4A is a scanning electron microscope image of a cross-section of a second electrode layer of a solid oxide cell according to an embodiment;

FIG. 4B is a scanning electron microscope image of a cross-section of a first region of the second electrode layer shown in FIG. 4A;

FIG. 4C is a scanning electron microscope image of a cross-section of a middle region of the second electrode layer shown in FIG. 4A;

FIG. 4D is a scanning electron microscope image of a cross-section of a second region of the second electrode layer shown in FIG. 4A;

FIG. 5 is a schematic cross-sectional view of an electrode-solid electrolyte assembly according to another embodiment;

FIG. 6 is a schematic cross-sectional view of a solid oxide cell according to an embodiment;

FIG. 7 is a schematic cross-sectional view of a solid oxide cell according to another embodiment;

FIG. 8 is an exploded perspective view of a solid oxide cell stack according to another embodiment;

FIG. 9 is an X-ray diffraction (XRD) spectrum of a solid ion conductor prepared in Preparation Example 1;

FIG. 10 is an XRD spectrum of a solid ion conductor prepared in Preparation Example 3;

FIG. 11 is an XRD spectrum of a solid ion conductor prepared in Preparation Example 4;

FIG. 12 is an XRD spectrum of a solid ion conductor prepared in Preparation Example 5;

FIG. 13 is a schematic diagram showing a crystal structure of a solid ion conductor that includes a metal oxide with a perovskite structure, prepared in Preparation Examples 1 to 5;

FIG. 14A is a plot showing changes in voltage during the application of a constant current to a symmetric solid oxide cell prepared in Comparative Example 1;

FIG. 14B is a Nyquist plot showing impedance measurement results of a symmetric solid oxide cell prepared in Comparative Example 1 before and after the application of a constant current;

FIG. 15A is a plot showing changes in voltage during the application of a constant current to a symmetric solid oxide cell prepared in Example 1;

FIG. 15B is a Nyquist plot showing the impedance measurement results of a symmetric solid oxide cell prepared in Example 1 before and after the application of a constant current;

FIGS. 16A, 16B, 16C, and 16D are high-angle annular dark field images (HAADF) STEM and energy dispersive x-ray spectroscopy (EDS) images of a cross-section between a solid electrolyte layer and a reaction barrier layer in a symmetric cell of Example 1;

FIGS. 17A, 17B, 17C, and 17D are HAADF STEM and EDS images of a cross-section between a solid electrolyte layer and a reaction barrier layer in a symmetric cell of Comparative Example 1;

FIG. 18 is a scanning electron microscope image of a cross-section of a full solid oxide cell prepared in Example 2;

FIG. 19A is a plot showing changes in voltage during the application of a constant current to a full solid oxide cell prepared in Example 2;

FIG. 19B is a Nyquist plot showing the impedance measurement results of a full solid oxide cell prepared in Example 2 before and after the application of a constant current;

FIG. 20 is a plot showing the performance in electrolysis cell mode and fuel cell mode of a full solid oxide cell prepared in Example 2;

FIG. 21 is a plot showing the performance in electrolysis cell mode and fuel cell mode of a full solid oxide cell prepared in Example 3;

FIG. 22A is a plot showing changes in voltage during the application of a constant current to a symmetric solid oxide cell prepared in Example 5; and

FIG. 22B is a Nyquist plot showing the impedance measurement results of a symmetric solid oxide cell prepared in Example 5 before the application of a constant current.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects.

Various embodiments are illustrated in the accompanying drawings. However, the inventive concept may be embodied in many other forms and should not be construed as limited to the embodiments described in the present specification. Rather, these embodiments are provided so that the present disclosure may be thorough and complete and so that those of ordinary skill in the art may fully understand the scope of the inventive concept. The same reference numerals denote identical components.

When a component is described as being “on” another component, it may be directly on that other component or an additional component may be interposed therebetween. In contrast, when a component is described as being “directly on” another component, no component is interposed therebetween.

Terms such as “first,” “second,” and “third” may be used herein to describe various components, elements, regions, layers, and/or sections, but those components, elements, regions, layers, and/or sections are not limited by those terms. These terms are used only to distinguish one component, element, region, layer, or section from another component, element, region, layer, or section. Accordingly, a first component, element, region, layer, or section described below may be referred to as a second component, element, region, layer, or section without departing from the teachings of the present specification.

The terminology used herein is for the purpose of describing particular embodiments only and is not intended to limit the inventive concept. The singular forms used herein are intended to include plural forms encompassing “at least one,” unless the context clearly indicates otherwise. The phrase “at least one” should not be construed as limited to the singular. As used in the present specification, the term “and/or” encompasses any and all combinations of one or more items in the listed elements. The terms “comprises” and/or “comprising” as used in the detailed description specify the presence of the stated features, regions, integers, steps, operations, components, and/or elements, and do not preclude the presence or addition of one or more other features, regions, integers, steps, operations, components, elements, and/or groups thereof.

Unless otherwise defined, all terms (including technical and scientific terms) used in the present specification have the same meanings as those commonly understood by one of ordinary skill in the art to which the present disclosure pertains. Terms defined in generally used dictionaries should be interpreted as having meanings consistent with the context of the relevant art and the present disclosure and should not be interpreted in an idealized or excessively formal sense.

Illustrative embodiments are described herein with reference to cross-sectional views that are schematic illustrations of idealized embodiments. Accordingly, variations from the illustrated shapes are to be expected, for example, as a result of manufacturing techniques and/or tolerances. Therefore, the embodiments described herein should not be construed as limited to the particular shapes of regions illustrated in the present specification, but should include variations in shapes that result, for example, from manufacturing. For instance, a region depicted or described as flat may typically exhibit roughness and/or nonlinear features. In addition, angles depicted as sharp may be rounded. Consequently, the regions shown in the drawings are inherently schematic, and their shapes are not intended to illustrate the exact shapes of the regions or to limit the scope of the claims.

“About” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations or ±5% of the stated value.

The term “essentially constant” means that a stated parameter, e.g., a composition of an element, compound, or composite, is constant across a dimension of a structural element or an article with little or no variation. Of course, a person of ordinary skill understands that there may likely exist some experimental variation of the measured parameter and even if such variation in the parameter is experimentally detectable the parameter value does not vary by more than ±5% across the stated dimension.

“Group” denotes a group of the periodic table according to the 1-18 group classification system of the International Union of Pure and Applied Chemistry (IUPAC).

In the present specification, “particle diameter” indicates the average diameter when the particles are spherical and the average major-axis length when the particles are non-spherical. The particle diameter may be measured by a particle size analyzer (PSA). The term “particle diameter” refers, for example, to an average particle diameter. The “average particle diameter” may be, for example, the median particle diameter D50.

In the present disclosure, the term “solid ion conductor” refers to a solid material having ionic conductivity with respect to oxygen ions (O²⁻) or protons (H⁺).

In the present disclosure, the term “metal” may include both metals and metalloids such as silicon and germanium, whether in elemental or ionic form.

In the present disclosure, the term “alloy” means a mixture of two or more metals.

In the present disclosure, the term “electrode” means an essential component that may include a material involved in an electrochemical reaction in an electrochemical cell, that supplies electrons used in the electrochemical reaction, or that releases electrons generated by the electrochemical reaction.

In the present disclosure, the term “solid electrolyte” refers to a solid-state medium that is disposed between spaced-apart electrodes, transports ions between the electrodes, and is not involved in the electrochemical reaction.

In the present disclosure, the term “fuel electrode” means an electrode that receives a fluid containing a fuel such as hydrogen in the fuel-cell mode of a solid oxide cell.

In the present disclosure, the term “fuel electrode” means an electrode that receives a fluid containing reactants such as water or carbon dioxide in the electrolysis-cell mode of a solid oxide cell.

In the present disclosure, the terms “air electrode” and “oxygen electrode” mean an electrode that receives a fluid containing oxygen in the fuel-cell mode of a solid oxide cell. The fluid containing oxygen may be, for example, air.

In the present disclosure, the terms “air electrode” and “oxygen electrode” mean an electrode at which a fluid containing oxygen is generated in the electrolysis-cell mode of a solid oxide cell.

In the present disclosure, the terms “positive electrode” and “cathode” mean an electrode at which reduction of oxygen occurs in the fuel-cell mode of a solid oxide cell.

In the present disclosure, the terms “negative electrode” and “cathode” mean an electrode at which reduction of reactants occurs in the electrolysis-cell mode of a solid oxide cell.

In the present disclosure, the terms “negative electrode” and “anode” mean an electrode at which oxidation of the fuel occurs in the fuel-cell mode of a solid oxide cell.

In the present disclosure, the terms “positive electrode” and “anode” mean an electrode at which oxidation of oxygen ions or the like occurs in the electrolysis-cell mode of a solid oxide cell.

Although specific embodiments have been described, alternatives, modifications, variations, improvements, and substantial equivalents that are not currently or reasonably foreseeable may occur to the applicant or to those skilled in the art. Accordingly, the appended claims, which may be filed and amended, are intended to encompass all such alternatives, modifications, variations, improvements, and substantial equivalents.

Hereinafter, an electrode-solid electrolyte assembly according to an embodiment, a solid oxide cell including the electrode-solid electrolyte assembly, and a method for manufacturing the electrode-solid electrolyte assembly will be described in further detail.

During operation of a solid oxide cell in electrolysis mode, high oxygen partial pressure may arise in local regions within an air electrode, thereby inducing formation of pores in the air electrode and/or a change in the stoichiometry of the air electrode. The pore formation and/or stoichiometry change in the air electrode may reduce active reaction sites in the air electrode, thereby increasing the overpotential in the solid oxide cell. The increased overpotential may further raise the local oxygen partial pressure in the air electrode, which may cause delamination between the air electrode and the solid electrolyte layer. Moreover, during operation of the solid oxide cell in electrolysis mode, metal on the surface of the air electrode may vaporize, and the vaporized metal may diffuse into the solid electrolyte layer, thereby increasing the interfacial resistance between the air electrode and the solid electrolyte layer. Accordingly, there is a need for a solid oxide cell that provides improved structural stability by suppressing delamination between the air electrode and the solid electrolyte layer and/or by suppressing an increase in interfacial resistance between the air electrode and the solid electrolyte layer.

### Electrode-Solid Electrolyte Assembly

An electrode-solid electrolyte assembly including an electrode and a solid electrolyte layer according to an embodiment includes:
a first electrode layer including a first solid ion conductor; and
   a second electrode layer disposed between the first electrode layer and a surface of the solid electrolyte layer, and including the first solid ion conductor and a second solid ion conductor. The first solid ion conductor may include a metal oxide having a perovskite-type structure. The metal oxide may include a first element and a second element occupying cuboctahedral sites of the perovskite-type structure. The first element and the second element are each independently elements belonging to Group 2 of the periodic table and have an atomic weight of 30 or more. The second electrode layer may have a content gradient in which the content of the second solid ion conductor transitions from a first content in a first region adjacent to the first electrode layer to a second content in a second region adjacent to the solid electrolyte layer, and the second content is greater than the first content, or the first content of the second solid ion conductor is essentially constant from the first region to the second region of the second electrode layer.

The inclusion of a metal oxide having a perovskite-type structure that contains the first element and the second element in the first electrode layer may suppress segregation of the first element and/or the second element within the first electrode layer and may inhibit defect formation, thereby contributing to improved structural stability of the first electrode layer.

The presence of both the first solid ion conductor and the second solid ion conductor in the second electrode layer may reduce the difference in thermal expansion coefficient between the first electrode layer and the solid electrolyte layer, thereby contributing to improved structural stability at the electrode-solid electrolyte interface in the solid oxide cell.

A content gradient in which the content of the second solid ion conductor increases from the first region adjacent to the first electrode layer to the second region adjacent to the solid electrolyte layer may increase the number of electrochemical reaction sites within the second electrode layer and may contribute to suppressing cation surface diffusion through the surface of the first solid ion conductor. As a result, the reversibility of the electrode reaction in the electrode-solid electrolyte assembly may be improved, and the increase in interfacial resistance between the electrode and the solid electrolyte layer may be more effectively suppressed.

### Electrode Layer Assembly

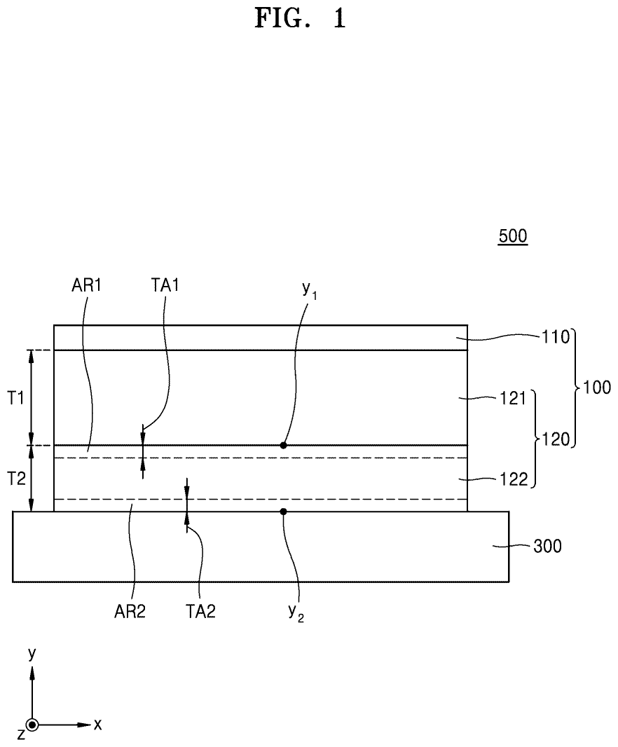

FIG. 1 is a schematic cross-sectional view of an electrode-solid electrolyte assembly according to an embodiment. Referring to FIG. 1, the electrode-solid electrolyte assembly 500 may include an electrode 100 and a solid electrolyte layer 300. The electrode 100 may include an electrode current collector 110 and an electrode layer assembly 120. The electrode layer assembly 120 may include a first electrode layer 121 and a second electrode layer 122. The first electrode layer 121 may include a first solid ion conductor. A second electrode layer 122 is included between the first electrode layer 121 and the solid electrolyte layer 300. The second electrode layer 122 may include a first solid ion conductor and a second solid ion conductor. The first solid ion conductor may include a metal oxide having a perovskite-type structure, and the metal oxide may include a first element and a second element occupying cuboctahedral sites of the perovskite-type structure. The first element and the second element may each independently be an element belonging to Group 2 of the periodic table and have an atomic weight of 30 or more.

The second electrode layer 122 may have a gradient in which the content of the second solid ion conductor transitions from a first content in a first region AR1 adjacent to the first electrode layer 121 to a second content in a second region AR2 adjacent to the solid electrolyte layer 300, the second content greater than the first content. Alternatively, the first content of the second solid ion conductor is essentially the same in both the first region AR1 and the second region AR2 of the second electrode layer.

By having this structure, the electrode-solid electrolyte assembly may improve the durability of the solid oxide cell including the electrode-solid electrolyte assembly and may enhance the reversibility of the electrolysis reaction. As the reversibility of the electrolysis reaction is improved, a greater amount of hydrogen and oxygen may be generated at the same voltage.

### Second Electrode Layer (I): Gradient in Second Solid Ion Conductor Content

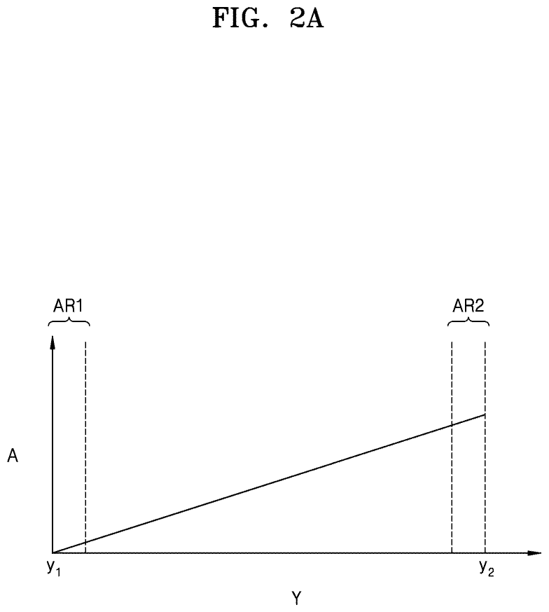

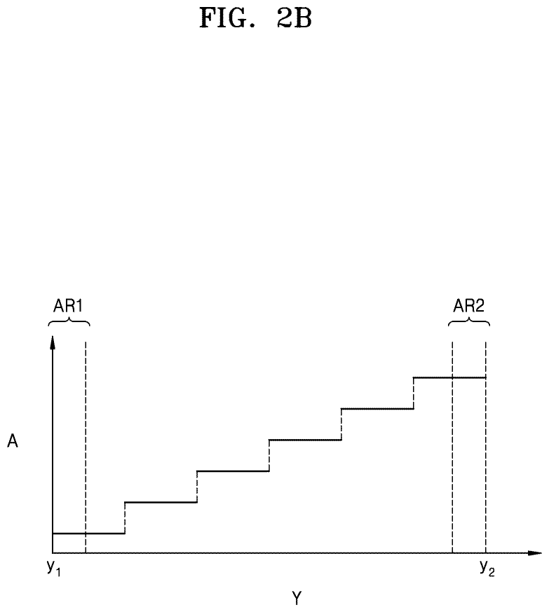

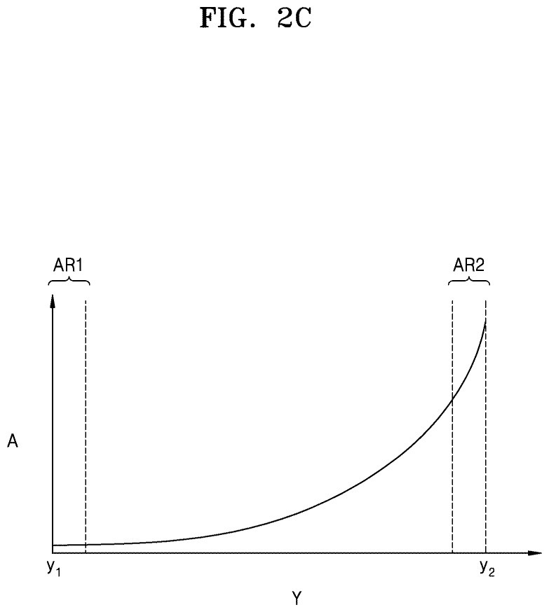

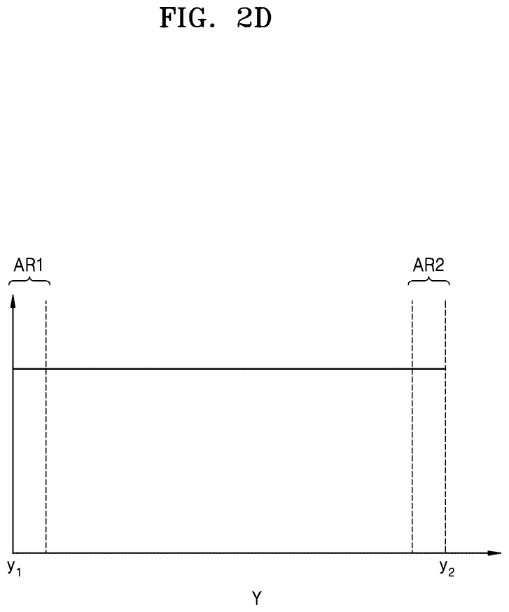

FIGS. 2A to 2C are graphs representing the content gradient of the second solid ion conductor along the thickness direction of the second electrode layer in the electrode-solid electrolyte assembly according to an embodiment, respectively.

Referring to FIG. 1 and FIGS. 2A to 2C, the second electrode layer 122 has a content gradient of the second solid ion conductor that transitions (or varies) from a first content in a first region adjacent to the first electrode layer 121 to a second content in a second region adjacent to the solid electrolyte layer 300, and the second content is greater than the first content. The gradient may include, for example, a continuous transitioning gradient as indicated in FIGS. 2A, 2C, a stepwise transitioning gradient as indicated in FIG. 2B, or a combination thereof. The continuous transitioning gradient may include, for example, a linearly transitioning gradient (FIG. 2A), a nonlinearly transitioning gradient (FIG. 2C), or a combination thereof. The nonlinearly transitioning gradient may include, for example, a gradient transitioning exponentially. When the second electrode layer 122 has a gradient in which the content gradient of the second solid ion conductor increases from the first region to the second region, delamination due to a difference in thermal expansion coefficient between the second electrode layer 122 and the solid electrolyte layer 300 may be minimized or prevented. At the same time, such a content gradient may effectively suppress cation diffusion through a surface of the first solid ion conductor, thereby suppressing an increase in interfacial resistance between the electrode 100 and the solid electrolyte layer 300.

Referring to FIG. 2A, the second electrode layer 122 may have, for example, a gradient that transitions continuously and linearly from a first content of the second solid ion conductor in a first region AR1 adjacent to the first electrode layer 121 to a second content in a second region AR2 adjacent to the solid electrolyte layer 300, where the second content is greater than the first content. Referring to FIG. 2B, the second electrode layer 122 may have, for example, a gradient that transitions stepwise or discontinuously from a first content of the second solid ion conductor in a first region AR1 adjacent to the first electrode layer 121 to a second content in a second region AR2 adjacent to the solid electrolyte layer 300, where the second content is greater than the first content. Referring to FIG. 2C, the second electrode layer 122 may have, for example, a gradient that transitions continuously and nonlinearly, more specifically, exponentially, from a first content of the second solid ion conductor in a first region adjacent to the first electrode layer 121 to a second content in a second region adjacent to the solid electrolyte layer 300, where the second content is greater than the first content. Referring to FIG. 1 and FIGS. 2A to 2C, the second electrode layer 122 shows an increasing gradient of the content A of the second solid ion conductor along the thickness direction (y direction) from point y1 to point y2 over a distance Y of the second electrode layer 122.

Referring to FIG. 1, the thickness T1 of the first electrode layer 121 may be greater than the thickness T2 of the second electrode layer 122. The ratio T1/T2 of the thickness T1 of the first electrode layer 121 to the thickness T2 of the second electrode layer 122 may be, for example, 1.1 or greater, 1.2 or greater, 1.5 or greater, or 2 or greater. The ratio T1/T2 of the thickness T1 of the first electrode layer 121 to the thickness T2 of the second electrode layer 122 may be, for example, about 1.1 to about 100, about 1.2 to about 50, about 1.5 to about 20, or about 2 to about 10. The ratio T1/T2 of the thickness T1 of the first electrode layer 121 to the thickness T2 of the second electrode layer 122 within such a range may contribute to further improvement in the electrolysis performance of a solid oxide cell including the electrode-solid electrolyte assembly 500.

Referring to FIG. 1, the thickness T1 of the first electrode layer 121 may be, for example, about 5 micrometers (μm) to about 100 μm, about 5 μm to about 50 μm, about 5 μm to about 30 μm, or about 5 μm to about 20 μm. By having such a dimensional thickness range, the structural stability of the electrode-solid electrolyte assembly 500 may be further improved.

Referring to FIG. 1, the thickness T2 of the second electrode layer 122 may be, for example, about 1 μm to about 15 μm, about 3 μm to about 15 μm, about 3 μm to about 12 μm, or about 5 μm to about 10 μm. The thickness T2 of the second electrode layer 122 within such a range may contribute to further improvement in the electrolysis performance of a solid oxide cell including the electrode-solid electrolyte assembly 500.

Referring to FIG. 1, the ratio TA1/T2 of the thickness TA1 of the first region AR1 adjacent to the first electrode layer 121 to the thickness T2 of the second electrode layer 122 may be, for example, 0.05 or less, 0.03 or less, or 0.01 or less. The ratio TA2/T2 of the thickness TA2 of the second region AR2 adjacent to the solid electrolyte layer 300 to the thickness T2 of the second electrode layer 122 may be, for example, 0.05 or less, 0.03 or less, or 0.01 or less.

Referring to FIG. 1 and FIGS. 2A, 2B, and 2C, the ratio A1/A2 of the first content A1 (not shown) of the second solid ion conductor in the first region AR1 to the second content A2 (not shown) of the second solid ion conductor in the second region AR2 may be 0.5 or less, 0.4 or less, 0.3 or less, 0.2 or less, or 0.1 or less. The ratio A1/A2 of the first content A1 of the second solid ion conductor in the first region AR1 to the second content A2 in the second region AR2 within such a range may contribute to further improvement in the electrolysis performance of a solid oxide cell including the electrode-solid electrolyte assembly 500.

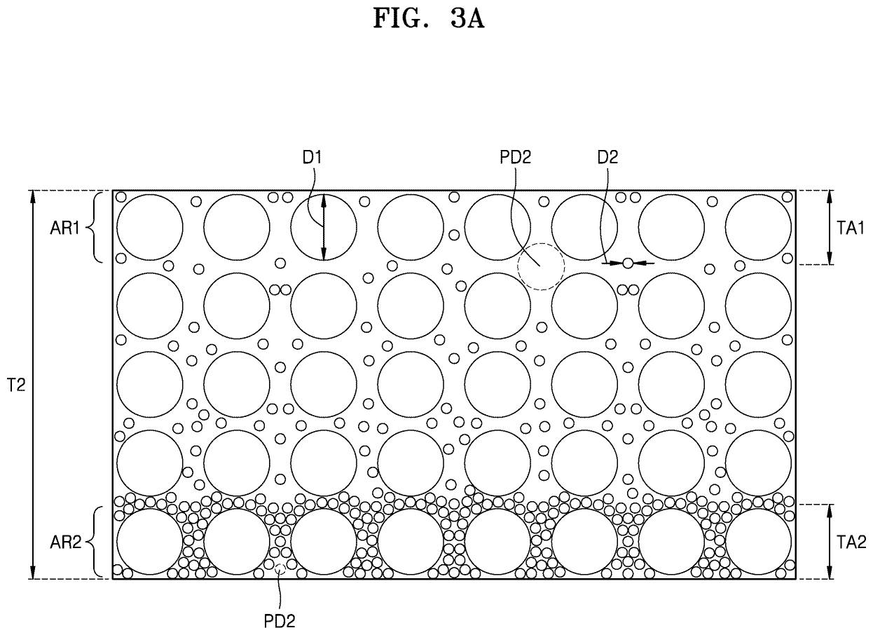

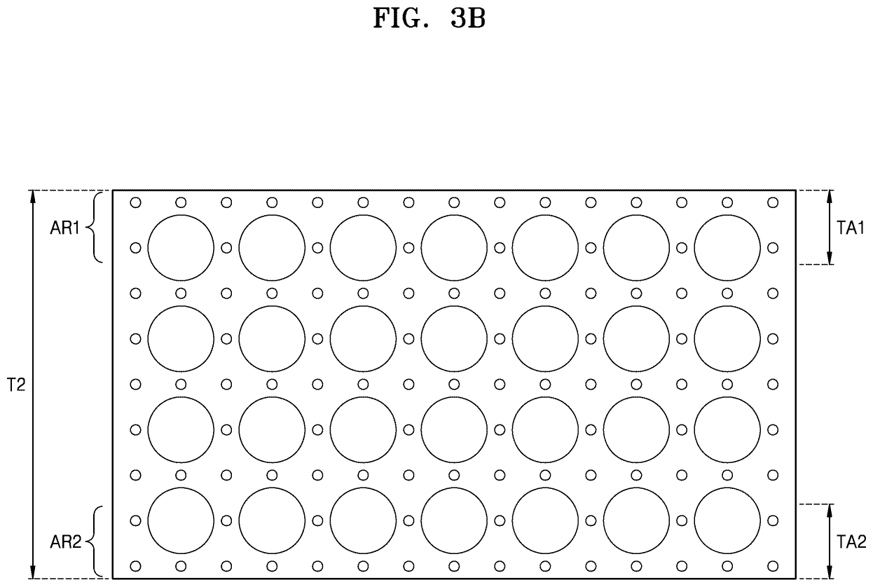

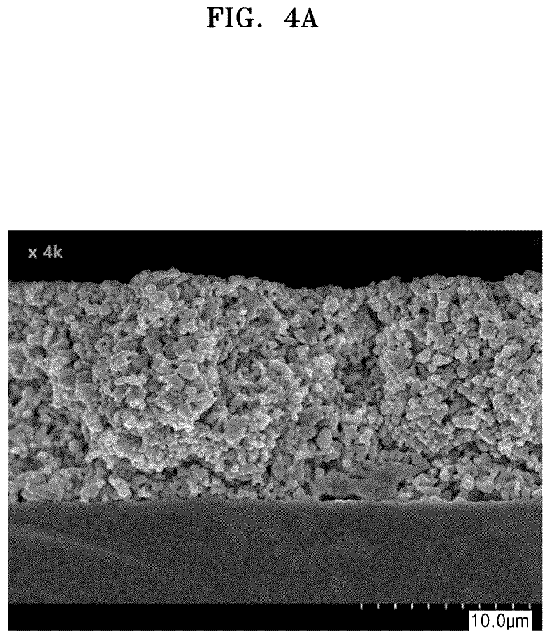

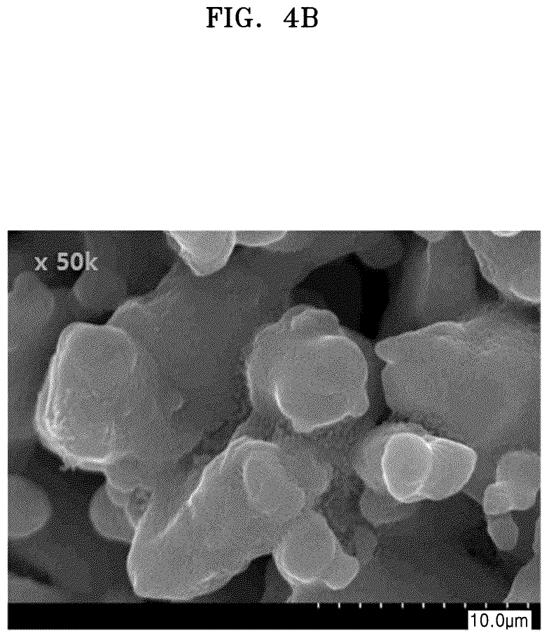

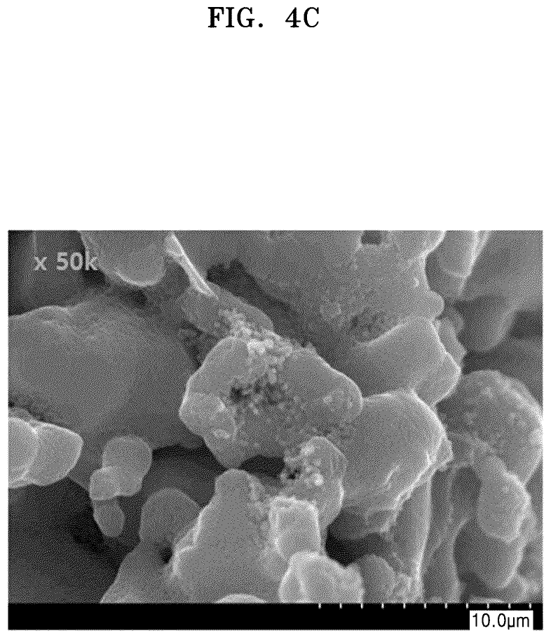

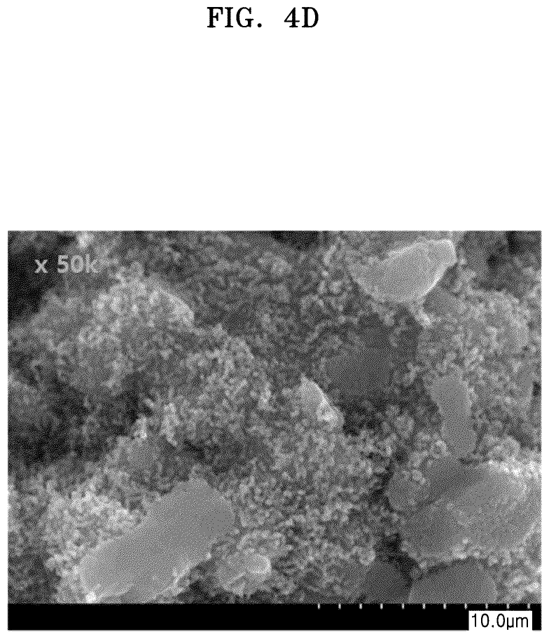

FIG. 3A is a schematic representation of a cross section of a second electrode layer in a electrode-solid electrolyte assembly according to an embodiment. FIG. 4A is a scanning electron microscope image of a cross section of the second electrode layer in another electrode-solid electrolyte assembly according to an embodiment. FIG. 4B is a scanning electron microscope image of a cross section of the first region of the second electrode layer in FIG. 4A. FIG. 4C is a scanning electron microscope image of a cross section of the middle region of the second electrode layer in FIG. 4A. FIG. 4D is a scanning electron microscope image of a cross section of the second region of the second electrode layer in FIG. 4A.

Referring to FIG. 1, FIG. 3A, FIG. 4A, and FIG. 4B, the first region AR1 may include a structural framework including the first solid ion conductor and the second solid ion conductor that coats or is in contact with at least a portion of the structural framework. The first region AR1 may include a first-1 region (not shown) that includes the second solid ion conductor in contact with the structural framework and a first-2 region (not shown) that includes the second solid ion conductor not in contact with the structural framework. The first-1 region in the first region AR1 is a region where the second solid ion conductor is in contact with the structural framework of the first solid ion conductor. The first-2 region is a region where the second solid ion conductor is not in contact with the structural framework of the first solid ion conductor. The area S1-1 of the first-1 region may be, for example, an area of the structural framework in contact with the second solid ion conductor with respect to an area occupied by the structural framework in FIG. 4B. The area S1-2 of the first-2 region may be the area not in contact with the second solid ion conductor with respect to an area occupied by the structural framework in FIG. 4B. The ratio S1-1/S1-2 of the area S1-1 of the first-1 region to the area S1-2 of the first-2 region may be, for example, less than 1, 0.9 or less, 0.8 or less, 0.5 or less, 0.3 or less, or 0.1 or less. By having the ratio S1-1/S1-2 of the area S1-1 of the first-1 region to the area S1-2 of the first-2 region in the first region AR1 be less than 1, it is possible to suppress an increase in interfacial resistance between the second electrode layer 122 and the first electrode layer 121, thereby improving the reversibility of the electrolysis reaction.

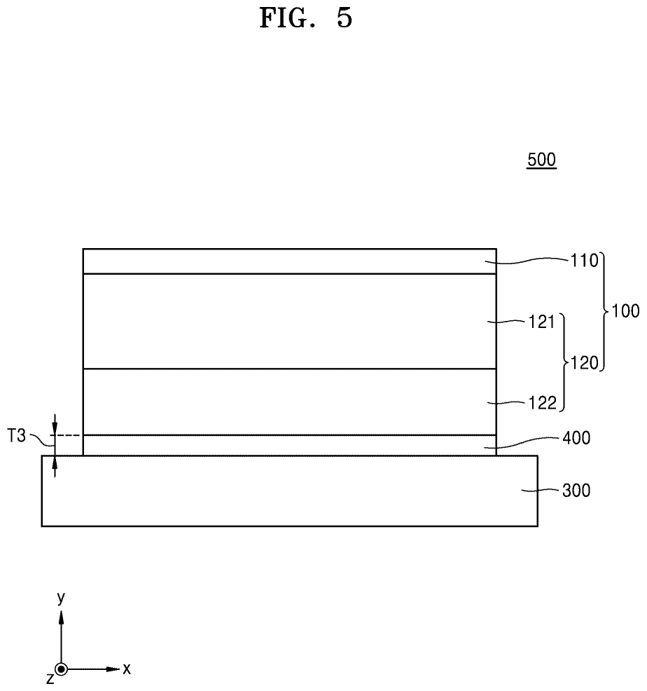

Referring to FIG. 1, FIG. 3A, FIG. 4A, and FIG. 4D, the second region AR2 may include a structural framework comprising the first solid ion conductor and a second solid ion conductor that may be in contact with at least a portion of the structural framework. The second region AR2 may include a second-1 region that includes the second solid ion conductor that may be in contact with the structural framework and a second-2 region in which the second solid ion conductor is not in contact with the structural framework. The second-1 region in the second region AR2 is a region where the second solid ion conductor is in contact with the structural framework of the first solid ion conductor. The second-2 region is a region where the second solid ion conductor is not in contact with the structural framework of the first solid ion conductor. The area S2-1 of the second-1 region may be, for example, the area in contact with the second solid ion conductor with respect to the area occupied by the structural framework in FIG. 4D. The area S2-2 of the second-2 region may be the area not in contact with the second solid ion conductor with respect to the area occupied by the structural framework in FIG. 4D. The ratio S2-1/S2-2 of the area S2-1 of the second-1 region to the area S2-2 of the second-2 region may be, for example, greater than 1, 1.2 or more, 1.5 or more, 2 or more, 5 or more, or 10 or more. By having the ratio S2-1/S2-2 of the area S2-1 of the second-1 region to the area S2-2 of the second-2 region in the second region AR2 be greater than 1, it is possible to suppress an increase in interfacial resistance between the second electrode layer 122 and the solid electrolyte layer 300 and/or the reaction barrier layer 400 (see, FIG. 5), thereby improving the reversibility of the electrolysis reaction. Cation diffusion through the surface of the first solid ion conductor may be more effectively suppressed, thereby suppressing side reactions between the electrode 100 and the solid electrolyte layer 300. As a result, an increase in interfacial resistance between the electrode 100 and the solid electrolyte layer 300 may be suppressed.

Referring to FIG. 1, FIG. 3A, and FIGS. 4A to 4D, the content of the second solid ion conductor in the second electrode layer 122 may be, for example, 30 weight percent (wt %) or less, 25 wt % or less, 20 wt % or less, 15 wt % or less, or 10 wt % or less, based on the total weight content of the first solid ion conductor and the second solid ion conductor. The content of the second solid ion conductor in the second electrode layer 122 may be, for example, about 1 wt % to about 30 wt %, about 3 wt % to about 25 wt %, about 5 wt % to about 25 wt %, about 10 wt % to about 25 wt %, or about 10 wt % to about 20 wt %, based on the total weight content of the first solid ion conductor and the second solid ion conductor. By including the second solid ion conductor within such a range, the durability of the electrode-solid electrolyte assembly 500 may be improved, and the reversibility of the electrolysis reaction may be further enhanced.

Referring to FIG. 1, FIG. 3A, and FIGS. 4A to 4D, the first solid ion conductor may include first particles, and the second solid ion conductor may include second particles. The particle diameter D1 of the first particles may be, for example, greater than the particle diameter D2 of the second particles. The particle diameter may be measured, for example, using a particle size analyzer (PSA) based on laser diffraction. Alternatively, the particle diameter may be measured using the arithmetic average of the particle diameters determined from a scanning electron microscope image of a cross section of the second electrode layer 122, either by software or manually. The particle diameter may be, for example, a D50 particle diameter.

The diameter ratio D2/D1 of the particle diameter D2 of the second particles to the particle diameter D1 of the first particles may be, for example, 0.2 or less, 0.15 or less, 0.1 or less, 0.05 or less, or 0.02 or less. By having such a range of the ratio D2/D1 of the particle diameter D2 of the second particles to the particle diameter D1 of the first particles, a second electrode layer 122 having a content gradient may be more easily implemented. For example, in order to infiltrate second solid ion conductor particles into the interior of a porous second electrode layer precursor composed of a structural framework of the first solid ion conductor, the particle size of the second solid ion conductor particles may be smaller than the pore size of the porous second electrode layer precursor.

The particle diameter D1 of the first particles may be, for example, about 500 nm to about 5 μm, about 500 nm to about 3 μm, about 500 nm to about 2 μm, or about 500 nm to about 1.5 μm. By having such a particle diameter range, the first particles may facilitate more efficient diffusion of air within the porous second electrode layer 122. As a result, the reversibility of the electrolysis reaction in a solid oxide cell may be improved. The particle diameter D2 of the second particles may be, for example, about 10 nm to about 400 nm, about 10 nm to about 300 nm, about 10 nm to about 200 nm, or about 10 nm to about 100 nm. Because the second particles have such a particle diameter range, various types of content gradients may be easily introduced into the second electrode layer 122. As a result, various types of solid oxide cells may be easily implemented.

The aspect ratio of the first particles may be, for example, 2 or more, 2.5 or more, 3 or more, or 5 or more. By having such an aspect ratio range, the first particles may facilitate more efficient diffusion of air within the second electrode layer 122. The reversibility of the electrolysis reaction in a solid oxide cell may be improved. The aspect ratio of the second particles may be, for example, 2 or more, 2.5 or more, 3 or more, or 5 or more. By having such an aspect ratio range, the second particles may facilitate more efficient diffusion of air within the second electrode layer 122. The reversibility of the electrolysis reaction in the solid oxide cell 1000 may be improved.

Referring to FIG. 1, FIG. 3A, FIG. 4A, and FIG. 4D, a second electrode layer, e.g., a second air electrode layer, may include first pores P1 defined by an aggregate of adjacent first particles and second pores P2 defined by an aggregate of adjacent second particles. The first pore size PD1 may be, for example, greater than the second pore size PD2. The pore size may be measured, for example, by a gas adsorption method. The pore size may be measured, for example, using the arithmetic average of the sizes of pores determined from a scanning electron microscope image of a cross section of the second electrode layer 122, either by software or manually. The pore size may be, for example, the diameter of a spherical pore or the maximum distance between both ends of a non-spherical pore. The ratio PD2/PD1 of the second pore size PD2 to the first pore size PD1 may be, for example, 0.5 or less, 0.3 or less, 0.1 or less, 0.05 or less, or 0.01 or less. By having such a range of the ratio PD2/PD1, the reversibility of the electrolysis reaction in a solid oxide cell may be improved.

The second electrode layer, e.g., a second air electrode layer, may have a bimodal pore size distribution, with a first pore peak corresponding to the first pores and a second pore peak corresponding to the second pores, for example, as measured by a gas adsorption method. The presence of such a bimodal pore size distribution in the second electrode layer may contribute to improved reversibility of the electrolysis reaction in the solid oxide cell.

Referring to FIG. 1, FIG. 3A, and FIGS. 4A to 4D, the porosity PRA1 (not shown) of the second electrode layer 122 in the first region AR1 is greater than the porosity PRA2 (not shown) of the second electrode layer 122 in the second region AR2. The porosity PRA1 of the first region AR1 may be, for example, about 20% to about 50%. The porosity PRA2 of the second region AR2 may be, for example, about 1% to about 40%. The porosities PRA1 and PRA2 of the first region AR1 and the second region AR2, respectively, and the pore distribution of the second electrode layer 122 may be measured, for example, by a nitrogen adsorption method. Alternatively, the porosities PRA1 and PRA2 of the first region AR1 and the second region, respectively, and the pore distribution of the second electrode layer 122 may be measured, for example, by image analysis software based with a scanning electron microscope image of a cross section of the second electrode layer 122. The porosity ratio PRA2/PRA1 of the porosity PRA2 of the second electrode layer 122 in the second region AR2 to the porosity PRA1 of the second electrode layer 122 in the first region AR1 may be, for example, 0.9 or less, 0.8 or less, 0.7 or less, 0.5 or less, 0.3 or less, or 0.1 or less. When the porosity ratio PRA2/PRA1 falls within such a range, air may more readily diffuse through the second electrode layer 122 from the first region AR1 toward the second region AR2.

The second electrode layer 122 may include the first solid ion conductor and the second solid ion conductor.

The second solid ion conductor is a metal oxide distinct from the first solid ion conductor. The second solid ion conductor may be a metal oxide distinct from the first solid ion conductor, and may be any metal oxide used as a solid ion conductor in the art. The second solid ion conductor may be, for example, an ion-conductive metal oxide. The second solid ion conductor may include, for example, neodymium-doped ceria (NDC), gadolinium-doped ceria (GDC), samarium-doped ceria (SDC), yttria-stabilized zirconia (YSZ), scandia-stabilized zirconia, (ZrO₂/Sc₂O₃, ScSZ), strontium- and magnesium-doped lanthanum gallate (LSGM), or a combination thereof, but is not limited thereto. The first solid ion conductor included in the second electrode layer 122 may be selected from the first solid ion conductors used in the first electrode layer 121, described below.

### Second Electrode Layer (II): Without Gradient in Second Solid Ion Conductor Content

FIG. 2D is a graph showing that the second solid ion conductor has a first content along the thickness direction of the second electrode layer that is essentially constant from the first region to the second region in the electrode-solid electrolyte assembly 500 according to an embodiment. FIG. 3B is a schematic view of a cross section of the second electrode layer in a solid oxide cell according to another embodiment.

Referring to FIG. 1, FIG. 2D, and FIG. 3B, the second electrode layer 122 may include the first solid ion conductor and the second solid ion conductor. The second electrode layer 122 has a first content of the second solid ion conductor in a first region adjacent to the first electrode layer 121, and essentially the same first content in a second region adjacent to the solid electrolyte layer 300. In other words, the first content of second electrode layer 122 may be essentially constant as the second solid ion conductor transitions from the first region adjacent to the first electrode layer 121 to the second region adjacent to the solid electrolyte layer 300. In other words, one may understand that the content of the second solid ion conductor is essentially constant in the thickness direction Y (see, FIG. 2D). Referring to FIG. 1 and FIG. 2D, a content A of the second solid ion conductor in the second electrode layer 122 is shown to be constant along the thickness direction (y direction) from point y1 to point y2 over the distance Y of the second electrode layer 122.

Within the second electrode layer 122, the second solid ion conductor may be uniformly distributed within the second electrode layer 122. Of course, a person of ordinary skill would understand that a localized content gradient of the second solid ion conductor may unintentionally be present within the second electrode layer 122, for example, due to the mixing process of the first solid ion conductor and the second solid ion conductor, however, any such localized gradient, if present, would be minimal, and therefore, does not encompass the term “gradient” as used in the present specification.

The presence of a uniform content of the second solid ion conductor from the first region to the second region in the second electrode layer 122 helps prevent delamination between the electrode 100 and the solid electrolyte layer 300 caused by a difference in thermal expansion coefficient between the second electrode layer 122 and the solid electrolyte layer 300, and contributes to suppressing an increase in interfacial resistance between the electrode 100 and the solid electrolyte layer 300. The durability of the solid oxide cell 1000 may be improved.

The second solid ion conductor included in the second electrode layer 122 with a uniform gradient (constant first content) may be selected from the same second solid ion conductors used in the second electrode layer 122 having the gradient of the second solid ion conductor as described above. Moreover, the first solid ion conductor included in the second electrode layer 122 without a gradient of the second solid ion conductor may be selected from the first solid ion conductors used in the first electrode layer 121, which is described below.

### First Electrode Layer

Referring to FIGS. 1 to 5, the electrode-solid electrolyte assembly may include an electrode layer assembly. The electrode layer assembly 120 may include a first electrode layer 121 disposed on the second electrode layer 122. The first electrode layer 121 may or may not further include the second solid ion conductor. In some embodiments, the second solid ion conductor may be absent from the first electrode layer 121. When the second solid ion conductor is included in the first electrode layer 121, the second solid ion conductor may be selected from the second solid ion conductors used in the second electrode layer 122 described above. The inclusion of the first electrode layer 121 in the electrode-solid electrolyte assembly 500 may contribute to improving the structural stability of the electrode-solid electrolyte assembly 500.

The first electrode layer 121 may include a first solid ion conductor.

The first solid ion conductor may include a metal oxide having a perovskite structure. The metal oxide may include, for example, a first element, a second element, and a third element occupying cuboctahedral sites of the perovskite structure, and optionally, may include a fourth element and/or a fifth element occupying octahedral sites of the perovskite structure. The metal oxide may further include or may not include, for example, a sixth element occupying octahedral sites of the perovskite structure. The first element and the second element each may be an element belonging to Group 2 of the periodic table and having an atomic weight of 30 or more. The third element may be, for example, an element belonging to Group 3 of the periodic table. The fourth element and the fifth element may be, for example, each independently an element belonging to Groups 8 to 11 of the periodic table. The sixth element may be an element belonging to Group 3, Group 4, or Groups 6 to 12 of the periodic table. The respective molar content of each of the first element, the second element, or the third element may be 0.5 or less based on the total mole content of the first element, the second element, and the third element. The molar content of the first element, based on the total mole content of the first element, the second element, and the third element, may be, for example, about 0.01 to about 0.5, about 0.05 to about 0.5, about 0.05 to about 0.45, about 0.05 to about 0.4, about 0.05 to about 0.35, or about 0.05 to about 0.3. The molar content of the second element, based on the total moles content of the first element, the second element, and the third element, may be, for example, about 0.01 to about 0.5, about 0.05 to about 0.5, about 0.05 to about 0.45, about 0.05 to about 0.4, about 0.05 to about 0.35, or about 0.05 to about 0.3. The molar content of the third element, based on the total mole content of the first element, the second element, and the third element, may be, for example, about 0.01 to about 0.5, about 0.05 to about 0.5, about 0.05 to about 0.45, about 0.05 to about 0.4, about 0.05 to about 0.35, or about 0.05 to about 0.3. The molar content of each of the first element, the second element, or the third element may be, for example, the molar ratio of the respective element to the total number of moles of the first element, the second element, and the third element.

In the first solid ion conductor, by having the third element within the aforementioned molar content range, the coordination state of the first element and/or the second element at the cuboctahedral sites may be modified. For example, because the third element has a smaller ionic radius compared to the first element and/or the second element, the elastic energy caused by lattice distortion induced by the first element and/or the second element may be reduced. Due to the reduced elastic energy, the phase stability of the crystalline phase including the first to fifth elements or the first to sixth elements may be improved. Because the first element and/or the second element are in a modified coordination state, vaporization and/or diffusion of the first element and/or the second element during the operation of an oxide solid cell containing the first solid ion conductor may be suppressed. For example, in the first solid ion conductor, destabilization of the crystalline phase due to the volatilization of the first element and/or the second element may be suppressed. The vaporized first element and/or second element may diffuse, for example, into the solid electrolyte layer, thereby causing segregation of the first element and/or the second element. The segregated first element and/or second element may, for example, form an insulating phase between the solid electrolyte layer and the first electrode during the operation of an oxide solid cell. Because the third element is present within the aforementioned molar content range in the first solid ion conductor, the formation of an insulating phase may be suppressed. As a result, the structural stability of a oxide solid cell may be improved.

Because the first element and/or the second element are present within the aforementioned content ranges in the first solid ion conductor, the concentration of oxygen vacancies may increase, and oxygen vacancy ordering may be enhanced. This, in turn, may extend the ion conduction pathway. For example, the formation of defects such as a Brownmiller-like phase may be suppressed. Because the contents of the first element and/or the second element are within the aforementioned ranges and as the contents of the first element and/or the second element are reduced, segregation of the first element and/or the second element may be more effectively suppressed.

Because the first solid ion conductor includes the fourth element and the fifth element, the activation energy for oxygen transport (e.g., vacancy hopping) within the solid ion conductor may be reduced. Because the first solid ion conductor includes, for example, the fourth element and the fifth element, the first solid ion conductor may exhibit improved oxygen ion (O²⁻) conductivity. Because the first solid ion conductor includes the fourth element and the fifth element, the first solid ion conductor may be a mixed conductor that has ionic conductivity in addition to electronic conductivity.

Because the first solid ion conductor is a mixed conductor, the number of active reaction sites at two-phase boundaries such as solid-gas and solid-solid interfaces, may increase, and a high surface exchange reaction rate may be provided. At two-phase boundaries such as solid-gas or solid-solid interfaces, the reaction kinetics of the oxygen reduction reaction (ORR) and the oxygen evolution reaction (OER) may increase, and the phase stability of the crystalline phase may be improved. For example, uniform progress of the oxygen evolution reaction within the electrode may suppress a local increase in oxygen partial pressure within the electrode, thereby suppressing the generation of local stress inside the electrode and/or at the interface between the electrode and the solid electrolyte layer. For example, the thermal expansion coefficient (TEC) of the solid ion conductor may be reduced. Delamination between the electrode and the reaction barrier layer and/or the solid electrolyte layer may be suppressed. Even after prolonged operation of the solid oxide cell, degradation of the solid ion conductor may be suppressed.

Because the first solid ion conductor includes the sixth element, the lattice parameter of the solid ion conductor may be reduced. Because the first solid ion conductor has a reduced lattice parameter, its thermal expansion coefficient (TEC) may be further decreased. For example, a decrease in the bond strength between the fifth element and/or the sixth element and oxygen atoms at the octahedral sites may lower the activation energy for oxygen hopping. The first solid ion conductor may have further improved oxygen ion (O²⁻) conductivity.

In the first solid ion conductor, for example, the sum of the contents of the third element and the first element may be greater than the content of the second element. When the sum of the contents of the third element and the first element is greater than the content of the second element, lattice distortion and/or segregation of the first element, which may otherwise result from an excessive increase in the content of the first element, may be suppressed.

In the first solid ion conductor, for example, the sum of the contents of the first element and the second element may be equal to or greater than the content of the third element. When the sum of the contents of the first element and the second element is equal to or greater than the content of the third element, lattice distortion and/or a reduction in the concentration of oxygen vacancies, which may result from an excessive increase in the content of the third element, may be suppressed.

In the first solid ion conductor, for example, the sum of the contents of the third element and the second element may be equal to or greater than the content of the first element. When the sum of the contents of the third element and the second element is equal to or greater than the content of the first element, lattice distortion and/or segregation of the first element, which may result from an excessive increase in the content of the first element, may be suppressed.

The first solid ion conductor may include a metal oxide, and the metal oxide may include a cubic phase, a hexagonal phase, or a combination thereof. The metal oxide may include a cubic phase. The metal oxide may include a cubic phase, and the phase fraction of the cubic phase may be from 95 wt % to 100 wt % based on the total crystalline phases contained in the metal oxide. When the metal oxide has such a phase fraction of the cubic phase, the solid ion conductor may have improved structural stability.

The metal oxide may include a combination of a cubic phase and a hexagonal phase. The phase fraction of the cubic phase may be, for example, 95 wt % or more, 97 wt % or more, or 99 wt % or more based on the combined cubic and hexagonal phases. When the metal oxide has such a phase fraction of the cubic phase, the first solid ion conductor may have improved structural stability. The phase fraction of the hexagonal phase may be, for example, 5 wt % or less, 3 wt % or less, or 1 wt % or less based on the combined cubic and hexagonal phases.

The metal oxide may be free of a tetragonal phase. A metal oxide including a cubic phase may have a single-layer perovskite structure. A metal oxide including a tetragonal phase may have a double-layer and/or triple-layer perovskite structure. A metal oxide having a single-layer perovskite structure with a cubic phase may be distinguishable from a metal oxide having a double-layer and/or triple-layer perovskite structure including a tetragonal phase.

The first solid ion conductor may include a metal oxide, and the metal oxide may have a composition represented by, for example, Formula 1:

M3ₐ₁M1_{b1}M2_{c1}M4_{d1}M5ₑ₁M6_{f1}O_{3-δ} <Formula 1>

In the formula,
0.01≤a1≤0.5, 0.01≤b1≤0.5, 0.01≤c1≤0.5, 0.1≤d1≤0.9, 0.1≤e1≤0.9, 0≤f1<0.2, and 0≤δ<1,
M3 may be an element belonging to Group 3 of the periodic table,
M1 and M2 may be independently elements belonging to Group 2 of the periodic table and have an atomic weight of 30 or more,
M4 and M5 may be independently elements belonging to Groups 8 to 11 of the periodic table,
M6 may be an element belonging to Group 3, Group 4, or Groups 6 to 12 of the periodic table, and
δ may be an oxygen vacancy.

The structural stability of the first solid ion conductor may be further enhanced when the metal oxide has the composition represented by Formula 1.

For example, in the formula, a1 may satisfy 0.05≤a1≤0.5, 0.05≤a1≤0.45, 0.05≤a1≤0.4, 0.05≤a1≤0.35, or 0.05≤a1≤0.3. For example, in the formula, b1 may satisfy 0.05≤b1≤0.5, 0.05≤b1≤0.45, 0.05≤b1≤0.4, 0.05≤b1≤0.35, or 0.05≤b1≤0.3. For example, in the formula, c1 may satisfy 0.05≤c1≤0.5, 0.05≤c1≤0.45, 0.05≤c1≤0.4, 0.05≤c1≤0.35, or 0.05≤c1≤0.3. For example, in the formula, d1 may satisfy 0.3≤d1≤0.9, 0.5≤d1≤0.9, 0.55≤d1≤0.9, 0.6≤d1≤0.9, or 0.7≤d1≤0.9. For example, in the formula, e1 may satisfy 0.1≤e1≤0.8, 0.1≤e1≤0.7, 0.1≤e1≤0.5, 0.2≤e1≤0.5, or 0.2≤e1≤0.45. For example, in the formula, f1 may satisfy 0.01≤f1≤0.2, 0.01≤f1≤0.17, 0.01≤f1≤0.15, 0.01≤f1≤0.13, or 0.05≤f1≤0.13.

For example, in the formula, a1+b1+c1=1. For example, in the formula, d1+e1+f1=1. For example, in the formula, d1>(e1+f1).

In the formula, M3 may include, for example, a lanthanide element, Sc, Y, or a combination thereof. The inclusion of such elements as M3 may further improve the phase stability of the solid ion conductor. The lanthanide element may include, for example, La, Ce, Pr, Nd, Pm, Sm, Eu, Gd, Tb, Dy, Ho, Er, Tm, Yb, Lu, or a combination thereof. The lanthanide element may particularly include La, Pr, Nd, or a combination thereof.

In the formula, M1 and M2 may independently include, for example, Ca, Sr, Ba, Ra, or a combination thereof. The inclusion of such metals as M1 and M2 may further enhance the oxygen ion conductivity of the solid ion conductor. M1 and M2 may not include, for example, Mg.

In the formula, the valence of M3 may be greater than the valence of M1, for example. When the valence of M3 is greater than that of M1, lattice distortion may be alleviated, thereby improving phase stability. The structural stability of the first solid ion conductor may be improved. The difference in valence between M3 and M1 may be, for example, 0.5 or more, 1 or more, or 1.5 or more. The valences of M3 and M1 may be determined, for example, by XRD, XPS, EDX, or the like.

In the formula, the ionic radius of M3 may be smaller than the ionic radius of M1, for example. When the ionic radius of M3 is smaller than that of M1, lattice distortion may be alleviated, thereby improving phase stability. The structural stability of the first solid ion conductor may be improved. The ionic radius of M3 may be, for example, 120 μm or less. The ionic radius of M3 may be, for example, about 100 μm to about 120 μm or about 115 μm to about 120 μm. The ionic radius of M1 may be, for example, 130 μm or more. The ionic radius of M1 may be, for example, about 130 μm to about 160 μm or about 130 μm to about 150 μm. The ionic radii of M3 and M1 may be cation ionic radii. The ionic radii of M3 and M1 may, for example, be determined from the valences of M3 and M1. Alternatively, the ionic radii of M3 and M1 may be determined using XRD, XPS, EDX, or the like.

The first solid ion conductor may include a metal oxide, and the metal oxide may, for example, have a composition represented by Formula 2:

Laₐ₂Sr_{b2}Ba_{c2}M4_{d2}M5ₑ₂M6_{f2}O_{3-δ} <Formula 2>

In the formula,
0.01≤a2≤0.5, 0.01≤b2≤0.5, 0.01≤c2≤0.5, 0.1≤d2≤0.9, 0.1≤e2≤0.9, 0≤f2<0.2, and 0≤δ<1,
M4 and M5 may be each independently an element belonging to Groups 8 to 11 of the periodic table,
M6 may be an element belonging to Group 3, Group 4, or Groups 7 to 12 of the periodic table, wherein if M6 is a Group 3 element, M6 is an element having an atomic weight of 150 or more, and
δ may be an oxygen vacancy.

The structural stability of the first solid ion conductor may be further enhanced when the metal oxide has the composition represented by Formula 2.

For example, in the formula, a2 may satisfy 0.05≤a2≤0.5, 0.05≤a2≤0.45, 0.05≤a2≤0.4, 0.05≤a2≤0.35, or 0.05≤a2≤0.3. For example, in the formula, b2 may satisfy 0.05≤b2≤0.5, 0.05≤b2≤0.45, 0.05≤b2≤0.4, 0.05≤b2≤0.35, or 0.05≤b2≤0.3. For example, in the formula, c2 may satisfy 0.05≤c2≤0.5, 0.05≤c2≤0.45, 0.05≤c2≤0.4, 0.05≤c2≤0.35, or 0.05≤c2≤0.3. For example, in the formula, d2 may satisfy 0.3≤d2≤0.9, 0.5≤d2≤0.9, 0.55≤d2≤0.9, 0.6≤d2≤0.9, or 0.7≤d2≤0.9. For example, in the formula, e2 may satisfy 0.1≤e2≤0.8, 0.1≤e2≤0.7, 0.1≤e2≤0.5, 0.2≤e2≤0.5, or 0.2≤e2≤0.45. For example, in the formula, f2 may satisfy 0.01≤f2≤0.2, 0.01≤f2≤0.17, 0.01≤f2≤0.15, 0.01≤f2≤0.13, or 0.05≤f2≤0.13.

For example, in the formula, a2+b2+c2=1. For example, in the formula, d2+e2+f2=1. For example, in the formula, d2>(e2+f2).

In the formula, M4 and M5 may each independently include, for example, Ni, Co, Fe, Ru, Rh, or Pd. When M4 and M5 include such metals, the first solid ion conductor may provide ionic conductivity in addition to electronic conductivity, thereby forming a mixed conductor.

For example, in the formula, the valence of M4 may be greater than that of M5. When the valence of M4 is greater than that of M5 as described above, the oxygen vacancy concentration in the solid ion conductor may increase, thereby enhancing the oxygen ion conductivity of the first solid ion conductor.

The valence of M4 may be, for example, +3 or greater, +3.1 or greater, +3.2 or greater, +3.3 or greater, +3.4 or greater, or +3.5 or greater. The valence of M4 may be, for example, about +3 to about +4, about +3.1 to about +4, about +3.2 to about +4, about +3.3 to about +4, about +3.4 to about +4, or about +3.5 to about +4.

The valence of M5 may be, for example, less than +3, +2.9 or less, +2.8 or less, +2.7 or less, +2.6 or less, or +2.5 or less. The valence of M5 may be, for example, about +2 to less than +3, about +2 to about +2.9, about +2 to about +2.8, about +2 to about +2.7, about +2 to about +2.6, or about +2 to about +2.5.

In the formula, M6 may include, for example, Zn, Mn, Yb, Ni, Cu, Ti, Ho, or a combination thereof. The inclusion of M6 may further enhance the thermal stability of the first solid ion conductor.

The valence of M6 may include, for example, +1, +2, +3, +4, +5, +6, or a combination thereof. The combination of the aforementioned valence states may refer to the average value of the multiple oxidation states. The valence of M6 may be determined using, for example, XRD, XPS, EDX, or the like.

The first solid ion conductor may include a metal oxide, and the metal oxide may, for example, have a composition represented by Formula 3:

Laₐ₃Sr_{b3}Ba_{c3}Co_{d3}Feₑ₃O_{3-δ} <Formula 3>

In the formula,
0.05≤a3≤0.5, 0.05≤b3≤0.5, 0.05≤c3≤0.45, 0.3<d3<0.9, 0.1≤e3≤0.8, 00<1, and d3>e3,
δ may be an oxygen vacancy.

The structural stability of the first solid ion conductor may be further enhanced when the metal oxide has the composition represented by Formula 3.

For example, in the formula, a3 may satisfy 0.05≤a3≤0.5, 0.05≤a3≤0.45, 0.05≤a3≤0.4, 0.05≤a3≤0.35, or 0.05≤a3≤0.3. For example, in the formula, a3 may satisfy 0.1≤a3≤0.5, 0.1≤a3≤0.45, 0.1≤a3≤0.4, 0.1≤a3≤0.35, or 0.1≤a3≤0.3. For example, in the formula, b3 may satisfy 0.05≤b3≤0.5, 0.05≤b3≤0.45, 0.05≤b3≤0.4, 0.05≤b3≤0.35, or 0.05≤b3≤0.3. For example, in the formula, c3 may satisfy 0.05≤c3≤0.45, 0.05≤c3≤0.4, 0.05≤c3≤0.35, or 0.05≤c3≤0.3. For example, in the formula, d3 may satisfy 0.3≤d3≤0.9, 0.5≤d3≤0.9, 0.55≤d3≤0.9, 0.6≤d3≤0.9, or 0.7≤d3≤0.9. For example, in the formula, e3 may satisfy 0.1≤e3≤0.8, 0.1≤e3≤0.7, 0.1≤e3≤0.5, 0.2≤e3≤0.5, 0.2≤e3≤0.45 or 0.2≤e3≤0.4.

For example, in the formula, a3+b3+c3=1. For example, in the formula, d3+e3=1.

The first solid ion conductor may include a metal oxide, and the metal oxide may, for example, have a composition represented by Formulae 4A to 4G:

Laₐ₄Sr_{b4}Ba_{c4}Co_{d4}Feₑ₄Zn_{f4}O_{3-δ} <Formula 4A>

Laₐ₄Sr_{b4}Ba_{c4}Co_{d4}Feₑ₄Mn_{f4}O_{3-δ} <Formula 4B>

Laₐ₄Sr_{b4}Ba_{c4}Co_{d4}Feₑ₄Yb_{f4}O_{3-δ} <Formula 4C>

Laₐ₄Sr_{b4}Ba_{c4}Co_{d4}Feₑ₄Ni_{f4}O_{3-δ} <Formula 4D>

Laₐ₄Sr_{b4}Ba_{c4}Co_{d4}Feₑ₄Cu_{f4}O_{3-δ} <Formula 4E>

Laₐ₄Sr_{b4}Ba_{c4}Co_{d4}Feₑ₄Ti_{f4}O_{3-δ} <Formula 4F>

Laₐ₄Sr_{b4}Ba_{c4}Co_{d4}Feₑ₄Ho_{f4}O_{3-δ} <Formula 4G>

In the formulae above,
0.05≤a4≤0.5, 0.05≤b4≤0.5, 0.05≤c4≤0.45, 0.3≤d4≤0.9, 0.1≤e4≤0.8, 0.01≤f4≤0.2, 0≤δ<1, and d4>(e4+f4),
δ may be an oxygen vacancy.

The structural stability of the first solid ion conductor may be further enhanced when the metal oxide has the composition represented by Formulas 4A to 4G.

For example, in the formulas, a4 may satisfy 0.05≤a4≤0.5, 0.05≤a4≤0.45, 0.05≤a4≤0.4, 0.05≤a4≤0.35, or 0.05≤a4≤0.3. For example, in the formulas, a4 may satisfy 0.1≤a4≤0.5, 0.1≤a4≤0.45, 0.1≤a4≤0.4, 0.1≤a4≤0.35, or 0.1≤a4≤0.3. For example, in the formulas, b4 may satisfy 0.05≤b4≤0.5, 0.05≤b4≤0.45, 0.05≤b4≤0.4, 0.05≤b4≤0.35, or 0.05≤b4≤0.3. For example, in the formulas, b4 may satisfy 0.1≤b4≤0.5, 0.1≤b4≤0.45, 0.1≤b4≤0.4, 0.1≤b4≤0.35, or 0.1≤b4≤0.3. For example, in the formulas, c4 may satisfy 0.05≤c4≤0.45, 0.05≤c4≤0.4, 0.05≤c4≤0.35, or 0.05≤c4≤0.3. For example, in the formulas, c4 may satisfy 0.1≤c4≤0.45, 0.1≤c4≤0.4, 0.1≤c4≤0.35, or 0.1≤c4≤0.3. For example, in the formulas, d4 may satisfy 0.3≤d4≤0.9, 0.5≤d4≤0.9, 0.55≤d4≤0.9, 0.6≤d4≤0.9, or 0.7≤d4≤0.9. For example, in the formulas, e4 may satisfy 0.1≤e4≤0.8, 0.1≤e4≤0.7, 0.1≤e4≤0.5, 0.1≤e4≤0.4, 0.2≤e4≤0.5, or 0.2≤e4≤0.45. For example, in the formulas, f4 may satisfy 0.01≤f4≤0.2, 0.01≤f4≤0.17, 0.01≤f4≤0.15, 0.01≤f4≤0.13, or 0.05≤f4≤0.13. For example, in the formulas, f4 may satisfy 0.1≤f4≤0.2, 0.1≤f4≤0.17, 0.1≤f4≤0.15, 0.1≤f4≤0.14, or 0.1≤f4≤0.13.

For example, in the formulas, a4+b4+c4=1. For example, in the formulas, d4+e4+f4=1.

The area specific resistance (ASR) of the first solid ion conductor, as measured by an AC impedance method at 700 °C, may be, for example, 0.5 Ohms square centimeter (Q·cm²) or less, 0.3 Ω·cm² or less, 0.1 Ω·cm² or less, or 0.05 Ω·cm² or less. The ASR may be, for example, the area specific resistance corresponding to the polarization resistance. Such ASR may be measured by an AC impedance method using a symmetric cell including the solid ion conductor.

The thermal expansion coefficient (TEC) of the first solid ion conductor may be 20×10⁻⁶/K or less, 17×10⁻⁶/K or less, or 15×10⁻⁶/K or less. When the first solid ion conductor has such a thermal expansion coefficient, delamination caused by a mismatch in thermal expansion coefficients between the air electrode and the reaction barrier layer and/or the solid electrolyte layer in a solid oxide cell operating at high temperatures may be suppressed. As a result, the thermal stability of the solid oxide cell may be improved.

The first solid ion conductor may be formed of a metal oxide comprising, for example, the aforementioned first to fifth elements or first to sixth elements. The first solid ion conductor may include, for example, a single crystalline phase. The first solid ion conductor may be, for example, a single crystal or a polycrystal including a single crystalline phase.

The oxygen ion diffusion coefficient of the first solid ion conductor at 700 °C may be 1×10⁻⁷ square centimeter per second (cm²/s) or more, 3×10⁻⁷ cm²/s or more, or 5×10⁻⁷ cm²/s or more.

When the first solid ion conductor has such an oxygen ion diffusion coefficient, the reversibility of the electrolysis reaction may be improved.

### Reaction Barrier Layer

FIG. 5 is a schematic cross-sectional view of an electrode-solid electrolyte assembly including a reaction barrier layer according to an embodiment.

The electrode-solid electrolyte assembly 500 may further include a reaction barrier layer 400 between the second electrode layer 122 and the solid electrolyte layer 300. The reaction barrier layer 400 may include the second solid ion conductor. The second solid ion conductor included in the reaction barrier layer 400 may be selected from the second solid ion conductors used in the second electrode layer 122. Because the electrode-solid electrolyte assembly 500 further includes the reaction barrier layer 400, delamination between the electrode 100 and the solid electrolyte layer 300 may be suppressed, and/or an increase in interfacial resistance may be suppressed.

The reaction barrier layer 400 may not include the first solid ion conductor. By excluding the first solid ion conductor from the reaction barrier layer 400, an increase in interfacial resistance between the electrode 100 and the solid electrolyte layer 300 may be more effectively suppressed.

The thickness of the reaction barrier layer 400 may be, for example, about 0.1 μm to about 10 μm, about 0.1 μm to about 5 μm, about 0.2 μm to about 3 μm, or about 0.5 μm to about 2 μm. When the reaction barrier layer 400 has a thickness within such a range, the structural stability of the electrode-solid electrolyte assembly 500 may be enhanced while suppressing a decrease in energy density of the electrode-solid electrolyte assembly 500.

The thickness T3 of the reaction barrier layer 400 may be, for example, smaller than the thickness T2 of the second electrode layer 122. The ratio T3/T2 of the thickness T3 of the reaction barrier layer 400 to the thickness T2 of the second electrode layer 122 may be, for example, 0.5 or less, 0.3 or less, 0.1 or less, or 0.05 or less. When the ratio T3/T2 of the thickness of the reaction barrier layer 400 to the thickness of the second electrode layer 122 falls within such a range, delamination between the electrode 100 and the solid electrolyte layer 300 may be more effectively suppressed.

### Interlayer

Referring to FIGS. 1 and 5, although not shown in the drawings, the electrode-solid electrolyte assembly 500 may further include an interlayer on one surface of the solid electrolyte layer 300 adjacent to the second electrode layer 122. The interlayer may be disposed, for example, between the second electrode layer 122 and the solid electrolyte layer 300, or between the reaction barrier layer 400 and the solid electrolyte layer 300.

The interlayer may include, for example, a metal oxide containing the first element or the second element and the seventh element. The seventh element may include, for example, a transition metal belonging to Groups 3 to 12 of the periodic table. The seventh element may be selected, for example, from metals of the metal oxide included in the solid electrolyte layer 300. A metal oxide including the first element or the second element and the seventh element may be, for example, a ternary oxide. The ternary oxide may include, for example, the first element or the second element, the seventh element, and oxygen. The ternary oxide may include, for example, barium, zirconium, and oxygen, or strontium, zirconium, and oxygen. The ternary oxide may be, for example, SrZrO₃, BaZrO₃, or the like.

The interlayer may include, for example, a crystalline phase having a perovskite-type structure. The crystallite size of the crystalline phase having the perovskite-type structure may be, for example, 20 nm or less, 15 nm or less, 10 nm or less, or 5 nm or less. The crystallite size may be measured from an XRD spectrum of the interlayer. The interlayer may include, for example, an insulating phase. The ionic conductivity of the insulating phase may be, for example, 0.01% or less of the ionic conductivity of the solid electrolyte layer 300.

In an XPS surface analysis of the electrode-solid electrolyte assembly including the interlayer, the ratio B1/B2 of the first element content B1 in the interlayer to the first element content B2 in the first electrode layer 121 may be, for example, 0.5 or less, 0.3 or less, 0.1 or less, 0.05 or less, or 0.01 or less. Because the interlayer has such a low B1/B2 ratio, an increase in interfacial resistance between the second electrode layer 122 and the solid electrolyte layer 300, or between the reaction barrier layer 400 and the solid electrolyte layer 300, may be more effectively suppressed. As a result, degradation of the solid oxide cell 1000 may be suppressed and the durability of the solid oxide cell 1000 may be further improved. If the ratio B1/B2 of the first element content B1 in the interlayer to the first element content B2 in the first electrode layer 121 is excessively high, interfacial resistance between the second electrode layer 122 and the solid electrolyte layer 300, or between the reaction barrier layer 400 and the solid electrolyte layer 300, may increase excessively, thereby readily degrading the performance of the solid oxide cell 1000.

### Electrode-Solid Electrolyte Assembly

FIG. 5 is a schematic cross-sectional view of an electrode-solid electrolyte assembly according to another embodiment.

Referring to FIGS. 1 and 5, the electrode-solid electrolyte assembly 500 may include an electrode 100 and a solid electrolyte layer 300. The electrode 100 may include an electrode current collector 110 and an electrode layer assembly 120. The electrode layer assembly 120 may include a first electrode layer 121 and a second electrode layer 122. The electrode current collector 110 may be, for example, a porous conductor including a plurality of pores. The electrode current collector 110 may include, for example, a metal mesh, a metal foam, a metal powder assembly, a porous carbon structure, or a combination thereof. The metal mesh, metal foam, or metal powder assembly may include, for example, stainless steel, nickel (Ni), cobalt (Co), manganese (Mn), aluminum (Al), indium (In), copper (Cu), magnesium (Mg), titanium (Ti), iron (Fe), zinc (Zn), germanium (Ge), silver (Ag), gold (Au), platinum (Pt), or an alloy thereof. The metal mesh or metal foam may include a stainless-steel framework and a coating layer disposed on a surface of that framework, and the coating layer may include nickel (Ni), cobalt (Co), manganese (Mn), aluminum (Al), indium (In), copper (Cu), magnesium (Mg), titanium (Ti), iron (Fe), zinc (Zn), germanium (Ge), silver (Ag), gold (Au), platinum (Pt), or an alloy of each of these metals.

The electrode layer assembly 120 may be formed by sequentially disposing the first electrode layer 121 and the second electrode layer 122.

The second electrode layer 122 may be formed by: preparing a first solid ion conductor paste including the first solid ion conductor and a solvent, coating the paste onto a substrate, and sintering to form a porous electrode-layer precursor; then preparing a second solid ion conductor infiltration solution containing the second solid ion conductor and a solvent, applying the solution onto the porous electrode-layer precursor, and drying and sintering. Alternatively, the second electrode layer 122 may be formed by preparing a mixed solid ion conductor paste including the first solid ion conductor, the second solid ion conductor, and a solvent, coating the paste onto a substrate, and sintering. The first electrode layer 121 may be formed by preparing a first solid ion conductor slurry including the first solid ion conductor and a solvent, coating the slurry onto the second electrode layer 122, and sintering. The substrate may be, for example, the air electrode current collector 110, the reaction barrier layer 400, or the solid electrolyte layer 300.

The electrode layer assembly 120, which may include the first electrode layer 121 and the second electrode layer 122, may further include, for example, a binder, a conductive additive, and the like.

The binder may include, for example, poly(vinylidene fluoride-hexafluoropropylene) copolymer (PVDF-HFP), polyvinylidene fluoride (PVDF), polyacrylonitrile (PAN), polymethyl methacrylate (PMMA), polytetrafluoroethylene (PTFE), polyacrylic acid (PAA), polyvinyl alcohol (PVA), carboxymethyl cellulose (CMC), starch, hydroxypropyl cellulose, regenerated cellulose, polyvinylpyrrolidone, tetrafluoroethylene, polyethylene, polypropylene, ethylene-propylene-diene monomer (EPDM), sulfonated EPDM, styrene-butadiene rubber, fluorinated rubber, copolymers of these materials, or combinations thereof. The binder content may be about 1 part by weight to about 10 parts by weight, or about 2 parts by weight to about 7 parts by weight, based on 100 parts by weight of the solid ion conductor. The binder may be partially or entirely removed by volatilization and/or carbonization during sintering of an air electrode catalyst layer, i.e., the electrode layer assembly 120. The binder may be omitted.

The conductive additive may include, for example, a carbon-based conductive additive. The carbon-based conductive additive may include, for example, carbon black, carbon fibers, graphite, fluorinated carbon, or a combination thereof. Carbon black may be, for example, acetylene black, Ketjen black, Super P carbon, channel black, furnace black, lamp black, thermal black, or a combination thereof. Graphite may be natural graphite or artificial graphite. An air electrode catalyst layer, i.e., the electrode layer assembly 120 may further include a metallic conductive additive, a metal-oxide conductive additive, or a polymer-based conductive additive in addition to the above-described carbon-based conductive additive. The metallic conductive additive may be, for example, metal fibers; metal powders such as aluminum powder or nickel powder; conductive metal oxides such as zinc oxide or potassium titanate; or polyethylene derivatives. The content of the conductive additive may be about 1 part by weight to about 10 parts by weight, or about 2 parts by weight to about 7 parts by weight, based on 100 parts by weight of the solid ion conductor. The conductive additive may be omitted.

A paste for forming the first electrode layer and/or a paste for forming the second electrode layer may include a solvent. The solvent may include, for example, ethanol, terpineol, and the like, but is not limited thereto.

The electrode-solid electrolyte assembly 500 may include a solid electrolyte layer 300.

The solid electrolyte layer 300 may be, for example, a solid oxide electrolyte layer. The solid electrolyte layer 300 may include a solid ion conductor, which may include, for example, an oxygen-ion conductor, a proton conductor, or a mixture thereof. As the oxygen-ion conductor, the solid electrolyte layer 300 may include a solid ion conductor containing the aforementioned first to fifth elements or first to sixth elements.

The solid electrolyte layer 300 may include, as the oxygen-ion conductor, an oxygen-ion-conductive metal oxide. The oxygen-ion-conductive metal oxide may include, for example, rare-earth-doped ceria (RDC) such as NDC (neodymium-doped ceria), GDC (gadolinium-doped ceria), or SDC (samarium-doped ceria); YSZ (yttria-stabilized zirconia, ZrO₂/Y₂O₃); ScSZ (scandia-stabilized zirconia, ZrO₂/Sc₂O₃); and LSGM (lanthanum gallate doped with strontium and magnesium), or combinations thereof. A solid oxide cell that includes a solid electrolyte layer 300 that includes an oxygen-ion conductor may be, for example, an oxygen-ion-conductive solid oxide cell.

The solid electrolyte layer 300 may include, as a proton conductor, a proton-conductive metal oxide. The proton-conductive metal oxide may include at least one selected from the group consisting of barium zirconate (BaZrO₃) doped with a trivalent element, barium cerate (BaCeO₃), barium zirconate cerate (BaZr₁₋ₓCeₓO₃, 0.05≤x≤0.95), strontium cerate (SrCeO₃), strontium zirconate (SrZrO₃), and strontium zirconate cerate (SrZr₁₋ₓCeₓO₃, 0.05≤x≤0.95). The trivalent element doped in a proton conductor may include, for example, yttrium (Y), a lanthanide element, or a combination thereof. The lanthanide element may be, for example, ytterbium (Yb). The proton conductor may include, for example, yttrium (Y)-doped barium zirconate, barium zirconate cerate doped with yttrium (Y) and ytterbium (Yb), or a combination thereof. The proton conductor may be, for example, BaZr₁₋ₓYₓO_{3-δ} (0.1≤x≤0.2, 2≤δ<3), BaZr_{0.1}Ce_{0.7}Y_{0.1}Yb_{0.1}O_{2.95}, or the like. A solid oxide cell 1000 employing a solid electrolyte layer 300 that includes a proton conductor may be, for example, a proton-conductive solid oxide cell.

A solid oxide cell employing a solid electrolyte layer 300 that includes a mixture of an oxygen-ion conductor and a proton conductor may be, for example, a mixed-conductive solid oxide cell.

The electrode-solid electrolyte assembly 500 may be used in an electrochemical device. The electrochemical device may be, for example, a metal oxide cell, a metal-air cell, a gas sensor, a capacitor, or the like. The electrode 100 included in the electrode-solid electrolyte assembly 500 may be used, for example, as a positive electrode, a negative electrode, a cathode, an anode, an air electrode, or a fuel electrode. The electrode 100 included in the electrode-solid electrolyte assembly 500 may be, for example, an air electrode.

### Solid Oxide Cell

A solid oxide cell according to another embodiment may include the aforementioned electrode-solid electrolyte assembly. The solid oxide cell may include the aforementioned electrode-solid electrolyte assembly and a fuel electrode disposed on the solid electrolyte layer of the assembly. The electrode of the electrode-solid electrolyte assembly may be an air electrode.

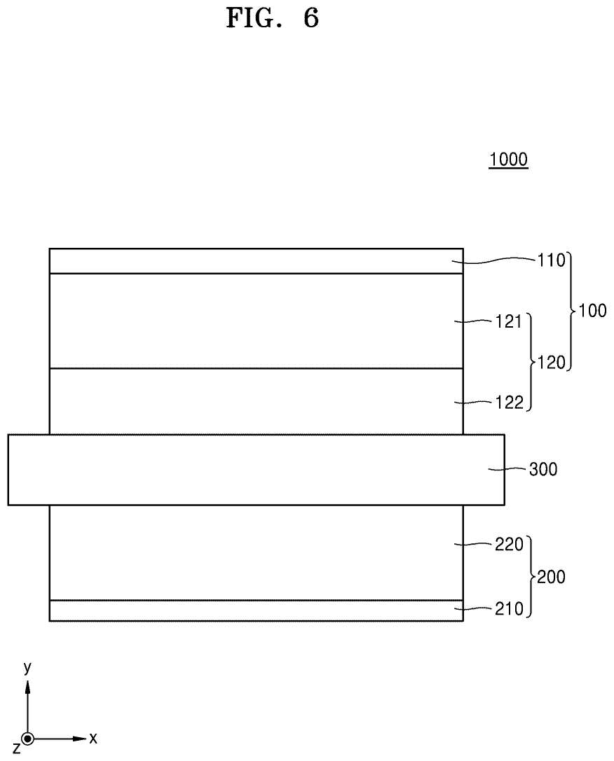

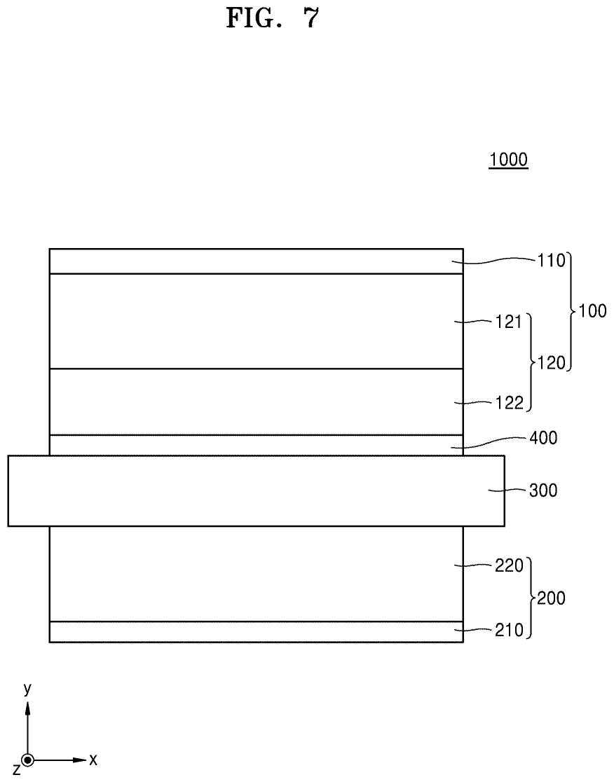

FIG. 6 is a schematic cross-sectional view of a solid oxide cell 1000 according to an embodiment. FIG. 7 is a schematic cross-sectional view of a solid oxide cell 1000 according to another embodiment.

Referring to FIGS. 6 and 7, the solid oxide cell 1000 may include a solid electrolyte layer 300; an air electrode 100 disposed on one surface of the solid electrolyte layer 300; and a fuel electrode 200 disposed on the opposite surface of the solid electrolyte layer 300. Referring to FIG. 7, a reaction barrier layer 400 may be disposed between the electrode layer assembly 120 and the solid electrolyte layer 300.

Although not shown in FIG. 7, an interlayer may additionally be disposed between the reaction barrier layer 400 and the solid electrolyte layer 300. Although not shown in FIG. 6, an interlayer may additionally be disposed between the second electrode layer 122 and the solid electrolyte layer 300.

By including the above-described electrode-solid electrolyte assembly 500, the solid oxide cell 1000 may provide improved structural stability and electrolysis performance in the electrolysis-cell mode.

The solid oxide cell 1000 may operate in both a fuel-cell mode, in which an oxygen reduction reaction occurs, and an electrolysis-cell mode, in which an oxygen evolution reaction occurs. For example, depending on the required conditions, electrical power may be generated in the fuel-cell mode, or fuel may be produced in the electrolysis-cell mode.

Referring to FIGS. 6 and 7, the solid oxide cell 1000 may include an air electrode 100, a fuel electrode 200, and a solid electrolyte layer 300 disposed between the air electrode 100 and the fuel electrode 200.

The air electrode 100 may perform an oxygen reduction reaction and/or an oxygen evolution reaction. The air electrode 100 may include the air electrode current collector 110 and an air electrode layer assembly, i.e., the electrode layer assembly 120.

A detailed description of the air electrode current collector 110 and the air electrode layer assembly, i.e., the electrode layer assembly 120 is provided in the above section describing the electrode layer assembly.

The fuel electrode 200 may provide diffusion of fuel and conduction of electrons. The fuel may include, for example, hydrogen, water vapor, carbon dioxide, or the like. The fuel electrode 200 may include a fuel electrode current collector 210 and a fuel electrode catalyst layer 220 disposed on the fuel electrode current collector 210. The fuel electrode current collector 210 may be selected from a metal mesh, a metal foam, a metal powder assembly, or a porous carbon structure that are used for the air electrode current collector 110. The material of the fuel electrode current collector 210 may be selected from the materials used as the air electrode current collector 110.

The solid ion conductor included in the fuel electrode layer 220 may be selected from the solid ion conductors used in the air electrode layer assembly 110.

The fuel electrode layer 220 may include a solid ion conductor that is distinct from the solid ion conductor used in the air electrode layer assembly 110. The solid ion conductor included in the fuel electrode layer 220 may include, for example, an oxygen-ion conductor, a proton conductor, or a mixture thereof. An oxygen-ion conductor, a proton conductor, or a mixture thereof additionally included in the fuel electrode layer 220 may be selected from the oxygen-ion conductors, proton conductors, or mixtures thereof used in the solid electrolyte layer 300.

The fuel electrode layer 220 may further include, for example, a catalyst metal.

The catalyst metal may enhance the electronic conductivity of the fuel electrode catalyst layer 220 and may also promote the generation of protons and electrons from fuel or the synthesis of fuel from protons and electrons. The catalyst metal may be, for example, a transition metal. The catalyst metal may be, for example, Ni, Cu, Pt, Pd, or a combination thereof.

The fuel electrode layer 220 may further include, for example, a carbonaceous material.

The fuel electrode layer 220 may be prepared, for example, by mixing a catalyst metal oxide, a solid ion conductor, and optionally a carbonaceous material precursor, followed by sintering. The catalyst metal oxide may be present in the fuel electrode layer 220 in a state reduced to the catalyst metal by hydrogen supplied before operation of the solid oxide cell 1000.

The solid oxide cell 1000 may operate, for example, at 500 °C to 1100 °C. At such operating temperatures, the solid electrolyte layer 300 may provide sufficiently high oxygen-ion conductivity and/or proton-ion conductivity.

Referring to FIG. 7, the solid oxide cell 1000 may further include a reaction barrier layer 400 between the solid electrolyte layer 300 and the air electrode 100.

The reaction barrier layer 400 can, for example, inhibit side reactions between the solid electrolyte layer 300 and the air electrode 100 and/or the fuel electrode 200, thereby improving the durability of the solid oxide cell 1000.

The reaction barrier layer 400 may include a solid ion conductor. The solid ion conductor used in the reaction barrier layer 400 may be selected from the oxygen-ion conductors, proton conductors, or mixtures thereof used in the solid electrolyte layer 300. The solid ion conductor used in the reaction barrier layer 400 may have a composition distinct from that of the solid ion conductor used in the solid electrolyte layer 300. Accordingly, the reaction barrier layer 400 may suppress side reactions between the solid ion conductor of the solid electrolyte layer 300 and the air electrode 100, thereby enhancing the durability of the solid oxide cell 1000.

The solid oxide cell 1000 may be, for example, a solid oxide fuel cell or a solid oxide electrolyzer cell.

The solid oxide cell 1000 may operate, for example, in an electrolysis-cell mode (EC mode), in which an electric field is applied between the fuel electrode 200 and the air electrode 100 to produce fuel at the fuel electrode 200. The EC mode may be referred to, for example, as a hydrogen-generation mode or, alternatively, as a water-splitting mode. The solid oxide cell 1000 may operate, for example, in a fuel-cell mode (FC mode) that generates electricity by supplying fuel to the fuel electrode 200 and air to the air electrode 100. When the solid oxide cell 1000 operates in the EC mode, that cell functions as a solid oxide electrolyzer cell. When the solid oxide cell 1000 operates in the FC mode, that cell functions as a solid oxide fuel cell.

An oxygen-ion-conductive solid oxide cell may operate in dual modes (FC mode and EC mode) according to the reaction equations given below.

### FC Mode

Fuel electrode: H₂+O²⁻→H₂O+2^{e-}
Air electrode: 1/2O₂+2e−→O²⁻
oxygen reduction reaction, ORR

### EC Mode

Fuel electrode: H₂O+2e−→H₂+O²⁻
Air electrode: O²⁻→1/2O₂+2e−
oxygen evolution reaction, OER

A proton-conductive solid oxide cell may operate in dual modes (FC mode and EC mode) according to the reaction equations given below.

### FC Mode

Fuel electrode: H₂→2H⁺+2e⁻
Air electrode: 2H⁺+1/2O₂+2e⁻→H₂O

### EC Mode

Fuel electrode: 2H⁺+2e⁻→H₂
Air electrode: H₂O→2H⁺+1/2O₂+2e⁻
(oxygen evolution reaction, OER)

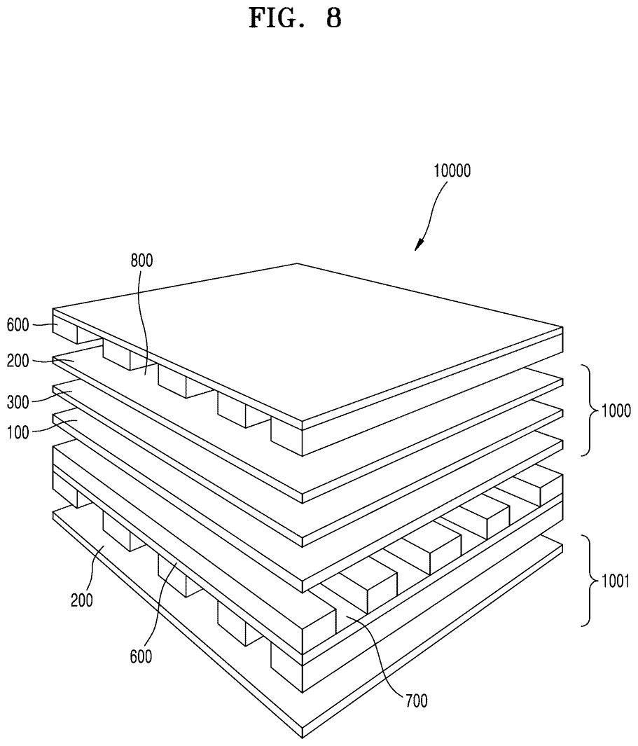

FIG. 8 is an exploded perspective view of a solid oxide cell stack according to another embodiment.

Referring to FIG. 8, the solid oxide cell stack 10000 may include a plurality of solid oxide cells 1000 and 1001 stacked in the thickness direction. Each solid oxide cell 1000 or 1001 may include an air electrode 100, a fuel electrode 200, and a solid electrolyte layer 300 disposed therebetween. The plurality of solid oxide cells 1000 and 1001 are stacked in the thickness direction, and an interconnect 600 is disposed between adjacent solid oxide cells 1000 and 1001. The interconnect 600 may include an air passage 700 adjacent to the air electrode 100, and a fuel passage 800 adjacent to the fuel electrode 200. Through the air passage 700, a fluid such as air or oxygen may be supplied to or discharged from the air electrode 100. Through the fuel passage 800, a fuel fluid such as hydrogen, water vapor, or carbon dioxide may be supplied to the fuel electrode 200, or a fluid such as hydrogen or carbon monoxide may be discharged.

The interconnect 600 may be an electrically conductive body. The interconnect 600 may include, for example, a metal. The interconnect 600 may have oxidation resistance, for example, to fluids supplied to the air electrode 100 and the fuel electrode 200 under the operating temperature of the solid oxide cell 1000. The interconnect 600 may have a thermal expansion coefficient (TEC) that is similar to or the same as the TEC of the ceramic components included in the solid electrolyte layer 300 of the solid oxide cells 1000 and 1001. As the interconnect 600, a ferritic stainless steel capable of forming a chromium oxide surface layer may be used, for example.

### Method of Preparing Electrode-Solid Electrolyte Assembly

A method of preparing an electrode-solid electrolyte assembly according to an embodiment may include: providing a solid electrolyte layer; providing a second electrode-layer precursor containing a first solid ion conductor on a surface of the solid electrolyte layer; infiltrating the second electrode-layer precursor with a composition including second solid ion conductor particles and a solvent to obtain a second electrode-layer precursor containing the second solid ion conductor particles; heat-treating the second electrode-layer precursor including the second solid ion conductor particles to form a second electrode layer; and positioning a first electrode layer on the second electrode layer to prepare the electrode-solid electrolyte assembly.

The second electrode layer may have a content gradient in which a content of the second solid ion conductor transitions from a first content in a first region adjacent to the first electrode layer to a second content in a second region adjacent to the solid electrolyte layer, and the second content is greater than the first content, or a first content of the second solid ion conductor is essentially constant from the first region to the second region of the second electrode layer. Moreover, the first solid ion conductor includes a metal oxide having a perovskite-type structure comprising a first element and a second element that occupy cuboctahedral sites of the perovskite-type structure, and the first element and the second element are each independently an element belonging to Group 2 of the periodic table and having an atomic weight of 30 or more.

As described in an embodiment, because the electrode-solid electrolyte assembly produced by this method may include a thickness-direction content gradient in the content of the second solid ion conductor within the second electrode layer, the durability of the assembly may be improved and the electrolysis performance may be enhanced.

A solid electrolyte layer may be provided. The solid electrolyte layer may be provided, for example, in the form of a pellet by pressing solid electrolyte powder into a defined shape. The solid electrolyte used for preparing the solid electrolyte layer may be, for example, an oxygen-ion conductor, a proton conductor, or the like. The solid electrolyte may be, for example, YSZ. Alternatively, the solid electrolyte layer may be commercially available.

A second electrode-layer precursor containing a first solid ion conductor is provided on one surface of the solid electrolyte layer. A first solid ion conductor paste may be prepared by mixing the first solid ion conductor with a solvent, and the paste may be coated onto one surface of the solid electrolyte layer and sintered to form the second electrode-layer precursor. The first solid ion conductor may be selected from the first solid ion conductors described above as used in the first electrode layer.

The first solid ion conductor may be, for example, Ba_{0.45}La_{0.45}Sr_{0.1}Co_{0.6}Fe_{0.4}O₃. The solvent is not particularly limited and may be, for example, ethanol. The coating method is not particularly limited and may include spin coating, screen-printing, or the like.

Next, a composition containing second solid ion conductor particles and a solvent is infiltrated into the second electrode-layer precursor to prepare a second electrode-layer precursor including the second solid ion conductor particles. The composition is prepared by mixing the second solid ion conductor particles with a solvent. The second solid ion conductor particles may be, for example, GDC. The solvent may be, for example, ethanol. The composition may be, for example, a dispersion in which the second solid ion conductor particles are dispersed in the solvent. The composition may be, for example, an infiltration solution. The content of the second solid ion conductor particles in the infiltration solution may be, for example, about 0.1 wt % to about 10 wt %, but is not particularly limited.

The infiltration solution is applied to the surface of the porous second electrode-layer precursor to infiltrate the second solid ion conductor particles into the interior of the second electrode-layer precursor. The particle size of the second solid ion conductor particles may be, for example, 200 nm or less, 100 nm or less, or 50 nm or less. The second solid ion conductor particles exhibit a content gradient in the thickness direction of the porous second electrode-layer precursor, increasing due to gravity within the porous structure.

The second electrode layer is prepared by heat-treating the second electrode-layer precursor including the second solid ion conductor particles. After drying the second electrode-layer precursor to remove the solvent, the precursor is heat-treated in air at, for example, about 800 °C to about 1200 °C for about 0.1 hours to about 24 hours to form the second electrode layer.

Next, the first electrode layer is formed on the second electrode layer to prepare the electrode-solid electrolyte assembly. A first solid ion conductor paste including the first solid ion conductor and a solvent is prepared, the paste is coated onto one surface of the second electrode layer, and sintered to form the first electrode layer. The first and second electrode layers form an electrode-layer laminate.

The method for manufacturing the electrode-solid electrolyte assembly may further include a step of providing a reaction barrier layer on a surface of the solid electrolyte layer. Before forming the second electrode layer on a surface of the solid electrolyte layer, the reaction barrier layer may be provided on the a surface of the solid electrolyte layer. A second solid ion conductor paste including the second solid ion conductor and a solvent is prepared, the paste is coated onto one surface of the solid electrolyte layer, and sintered to form the reaction barrier layer. The second solid ion conductor included in the reaction barrier layer may be selected from the second solid ion conductors used in the second electrode layer. The second solid ion conductor may be, for example, GDC.

Hereinafter, the present disclosure will be described in further detail with reference to Preparation Examples, Examples, and Comparative Examples; however, the scope of the disclosure is not limited to these examples.

### Preparation of First Solid Ion Conductor

Preparation Example 1: Ba_{0.45}La_{0.45}Sr_{0.1}Co_{0.6}Fe_{0.4}O₃

A mixture was prepared by mixing La(NO₃)₃·6H₂O as the first-element precursor, Sr(NO₃)₂ as the second-element precursor, BaN₂O₆ as the third-element precursor, Co(NO₃)₂·6H₂O as the fourth-element precursor, and Fe(NO₃)₃·9H₂O as the fifth-element precursor, in stoichiometric proportions. The prepared mixture was mixed with a citric acid at a weight ratio of 1:1, introduced into distilled water, and stirred to obtain a precursor solution (or dispersion).

The precursor solution was evaporated in an oven at 350 °C to yield a gelation powder. The gelation powder was calcined in a furnace at 1000 °C for 4 h to produce the first solid ion conductor in powder form. The composition of the first solid ion conductor was Ba_{0.45}La_{0.45}Sr_{0.1}Co_{0.6}Fe_{0.4}O₃.

Preparation Example 2: Ba_{0.45}La_{0.05}Sr_{0.5}Co_{0.6}Fe_{0.4}O₃

A first solid ion conductor was prepared in the same manner as in Preparation Example 1, except that the stoichiometric proportions of the precursors were changed. The resulting first solid ion conductor had a composition of Ba_{0.45}La_{0.05}Sr_{0.5}Co_{0.6}Fe_{0.4}O₃.

Preparation Example 3: Ba_{0.2}La_{0.3}Sr_{0.5}Co_{0.6}Fe_{0.4}O₃

A first solid ion conductor was prepared in the same manner as in Preparation Example 1, except that the stoichiometric proportions of the precursors were changed. The resulting first solid ion conductor had a composition of Ba_{0.2}La_{0.3}Sr_{0.5}Co_{0.6}Fe_{0.4}O₃.

Preparation Example 4: Ba_{0.2}La_{0.3}Sr_{0.5}Co_{0.6}Fe_{0.3}Zn_{0.1}O₃

A solid ion conductor was prepared in the same manner as in Preparation Example 1, except that Zn(NO₃)₂·6H₂O was additionally used as the sixth-element precursor and the stoichiometric proportions of the precursors were changed. The resulting first solid ion conductor had a composition of Ba_{0.2}La_{0.3}Sr_{0.5}Co_{0.6}Fe_{0.3}Zn_{0.1}O₃.

Preparation Example 5: Ba_{0.2}La_{0.3}Sr_{0.5}Co_{0.6}Fe_{0.2}Zn_{0.2}O₃

A solid ion conductor was prepared in the same manner as in Preparation Example 1, except that Zn(NO₃)₂·6H₂O was additionally used as the sixth-element precursor and the stoichiometric proportions of the precursors were changed. The resulting first solid ion conductor had a composition of Ba_{0.2}La_{0.3}Sr_{0.5}Co_{0.6}Fe_{0.2}Zn_{0.2}O₃.

### Evaluation Example 1: X-Ray Diffraction Analysis

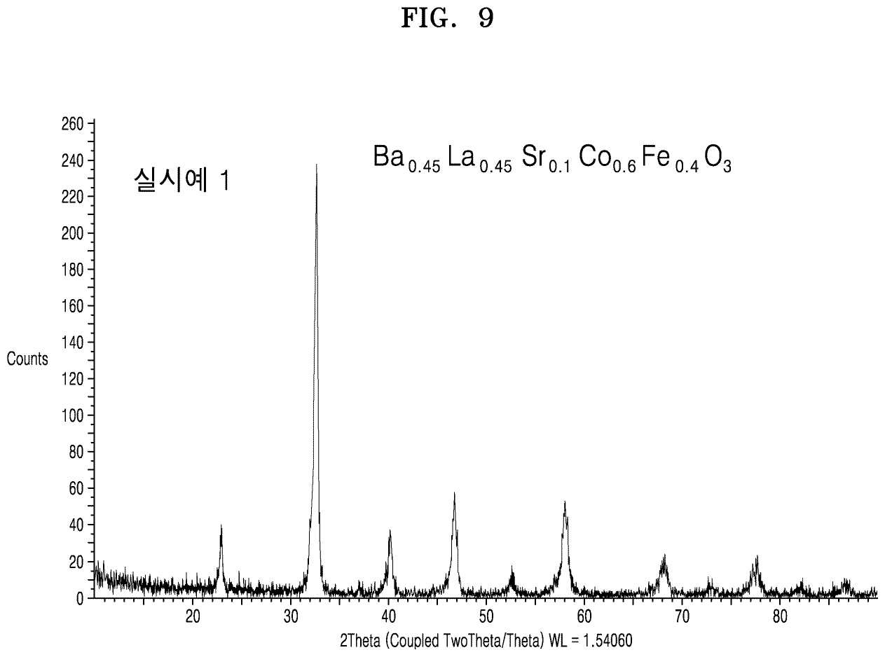

XRD spectra were measured for the solid ion conductors prepared in Preparation Examples 1 to 5, and portions of the respective spectra are shown in FIGS. 9 to 12. The XRD spectra were obtained using an X'Pert PRO (PANalytical) equipped with Cu Kα radiation (1.54056 Å).

FIG. 9 is the XRD spectrum of the solid ion conductor prepared in Preparation Example 1.

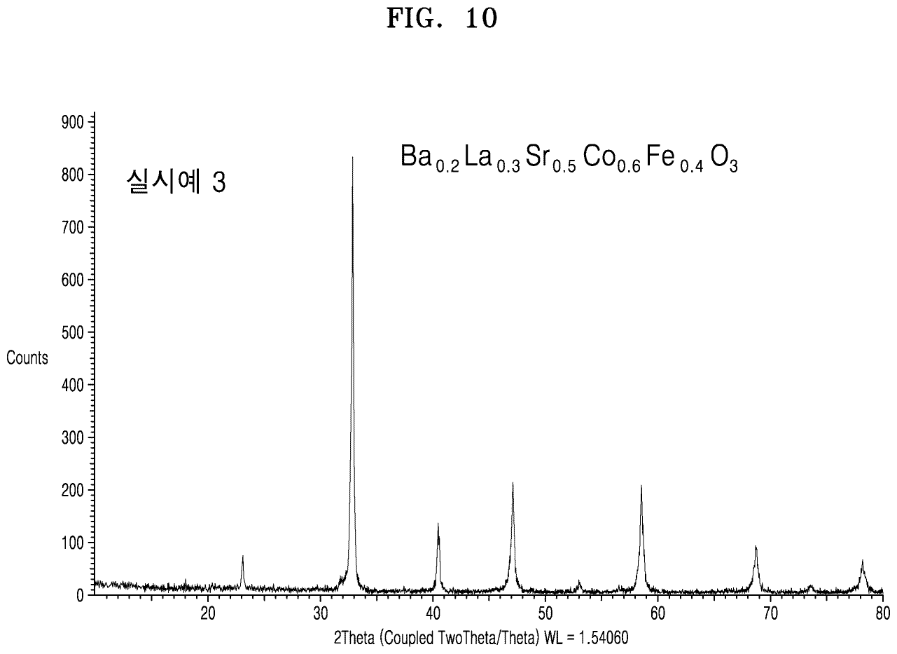

FIG. 10 is the XRD spectrum of the solid ion conductor prepared in Preparation Example 3.

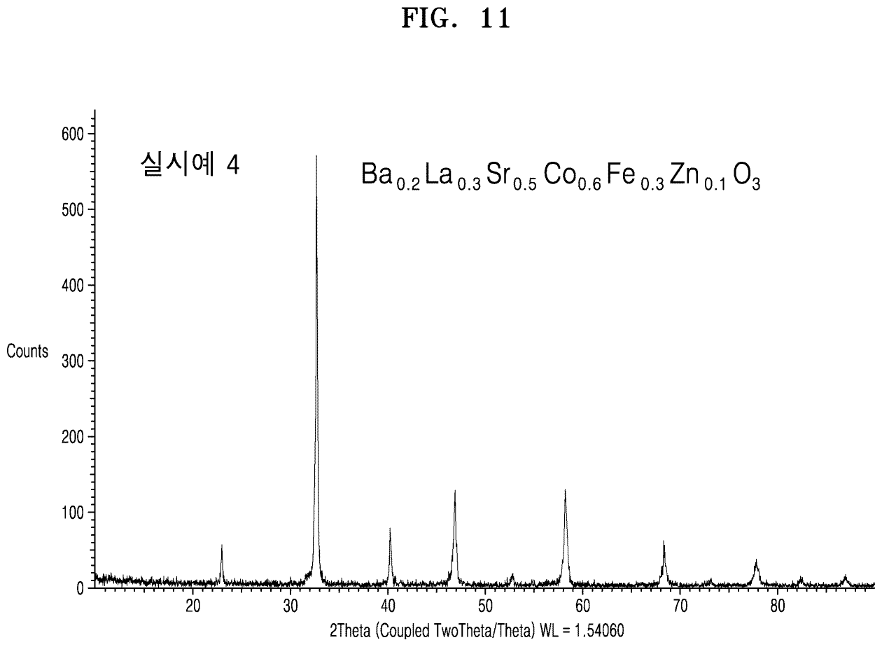

FIG. 11 is the XRD spectrum of the solid ion conductor prepared in Preparation Example 4.

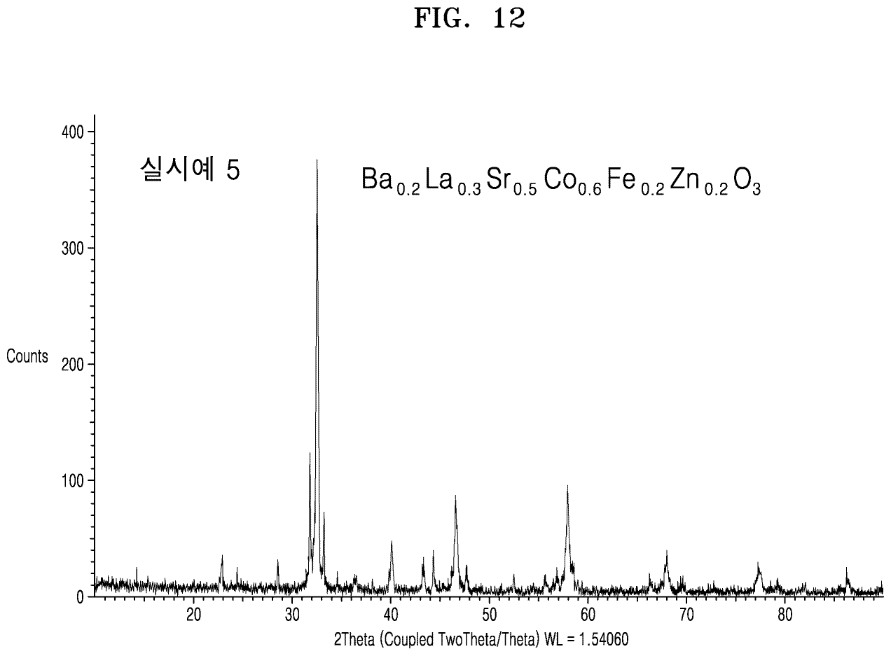

FIG. 12 is the XRD spectrum of the solid ion conductor prepared in Preparation Example 5.

As shown in FIGS. 9 to 12, the solid ion conductors prepared in Preparation Examples 1 and 3 to 5 exhibited characteristic peaks corresponding to a perovskite structure, confirming that they shared the same crystal structure.

As shown in FIG. 12, it was confirmed that the solid ion conductor prepared in Preparation Example 5 exhibited additional peaks, confirming the formation of a secondary phase.

Despite the compositional changes in Preparation Examples 1 and 3 to 5, no change in crystal structure was observed.

The solid ion conductors prepared in Preparation Examples 1 and 3 to 5 were confirmed to have a perovskite structure including a cubic phase. A tetragonal phase was not detected.

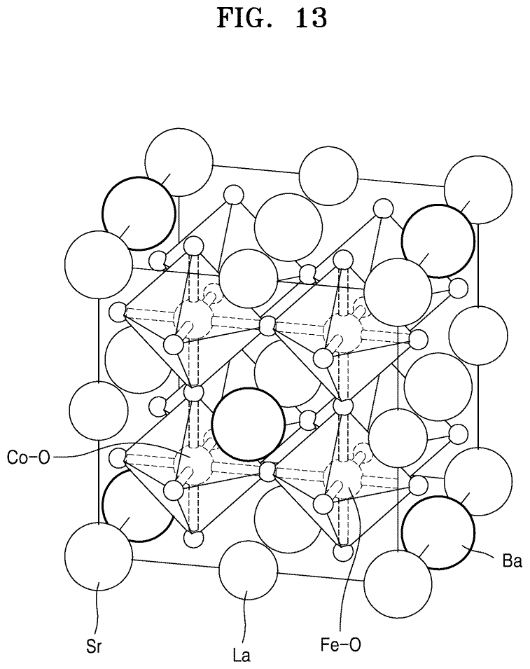

Referring to FIG. 13, in the solid ion conductors having a perovskite structure from Preparation Examples 1 to 5, Ba, La, and/or Sr occupy the 12-coordinated cuboctahedral sites, while Co, Fe, and/or Zn occupy the 6-coordinated octahedral sites.

### Electrode-Solid Electrolyte Assembly and Solid Oxide Cell: Symmetric Cell) (Simple-Mix Layer=Uniform Composition

Example 1: First Electrode Layer (BLSCF, 20 μm)/Second Electrode Layer (BLSCF+GDC, 5 μm)/Reaction Barrier Layer (GDC)/Solid Electrolyte Layer (YSZ)/Reaction Barrier Layer (GDC)/Second Electrode Layer (BLSCF+GDC, 5 μm)/First Electrode Layer (BLSCF, 20 μm) Structure, Symmetric Cell

### Preparation of Electrode-Solid Electrolyte Assembly and Solid Oxide Cell

YSZ powder was placed in a pelletizer, pressed under uniaxial pressure, and sintered in air at 1450 °C for 5 h to prepare a YSZ pellet 0.5 mm thick. A GDC paste (Ce_{0.9}Gd_{0.1}O₂, BET: 11.8 m²/g, FCM, USA) was screen-printed onto both faces of the YSZ pellet and sintered in air at 1200 °C for 2 h to obtain a first laminate having a reaction barrier layer (GDC layer)/solid electrolyte layer (YSZ layer)/reaction barrier layer (GDC layer) structure.

The first solid ion conductor powder prepared in Preparation Example 1 was ball-milled to obtain a milled first solid ion conductor powder. The milled first solid ion conductor powder and an ink vehicle solution (FCM) were mixed at a weight ratio of 2:1 to prepare a first solid ion conductor paste. The D50 average particle diameter of the milled first solid ion conductor (BLSCF) powder was about 1 μm.

A GDC paste (Ce_{0.9}Gd_{0.1}O₂, BET: 11.8 m²/g, FCM, USA) was prepared as the second solid ion conductor paste. The D50 average particle diameter of GDC was about 200 nm. A mixed solid ion conductor paste was prepared by mixing the first solid ion conductor paste with the second solid ion conductor paste. In the mixed solid ion conductor paste, 20 parts by weight of the second solid ion conductor were used per 100 parts by weight of the first solid ion conductor.

The mixed solid ion conductor paste was screen-printed onto the reaction barrier layer of the first laminate and sintered in air at 900 °C for 2 h to prepare a second laminate. The second laminate had the structure: second air electrode layer (BLSCF+GDC)/reaction barrier layer (GDC layer)/solid electrolyte layer (YSZ layer)/reaction barrier layer (GDC layer)/second air electrode layer (BLSCF+GDC). The thickness of the second air electrode layer in the second laminate was about 5 μm.

A first solid ion conductor paste was screen-printed onto the second air electrode layer of the second laminate and sintered in air at 900 °C for 2 h to prepare a third laminate. The third laminate had the structure: first air electrode layer (BLSCF)/second air electrode layer (BLSCF+GDC)/reaction barrier layer (GDC layer)/solid electrolyte layer (YSZ layer)/reaction barrier layer (GDC layer)/second air electrode layer (BLSCF+GDC)/first air electrode layer (BLSCF). The thickness of the first air electrode layer in the third laminate was about 20 μm.

Ag paste (H4580, Shoei Chemical, Japan) was coated onto the air electrodes on both sides of the third laminate, and an Ag mesh and wire were attached to fabricate a symmetric solid oxide cell.

Comparative Example 1: First Electrode Layer (BLSCF, 25 μm)/Reaction Barrier Layer (GDC)/Solid Electrolyte Layer (YSZ)/Reaction Barrier Layer (GDC)/First Electrode Layer (BLSCF, 25 μm) Structure, Symmetric Cell

An electrode-solid electrolyte assembly and a metal oxide cell were prepared in the same manner as in Example 1, except that the thickness of the first air electrode layer was changed to 25 μm to account for the omitted second electron layer, and of course, the second air electrode layer, that is, (BLSCF+GDC, 5 μm) was omitted from the solid oxide cell on both sides of the solid electrolyte.

### Evaluation Example 2: Durability Evaluation of Symmetric Cell

For the symmetric cell-type solid oxide cells prepared in Example 1 and Comparative Example 1, a constant current was applied at a current density of 1.0 A/cm² at 700 °C for 500 hours, and the change in voltage over time was measured.

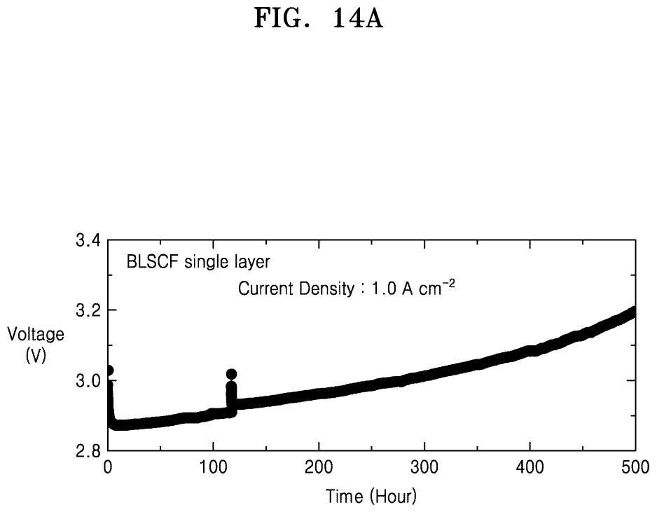

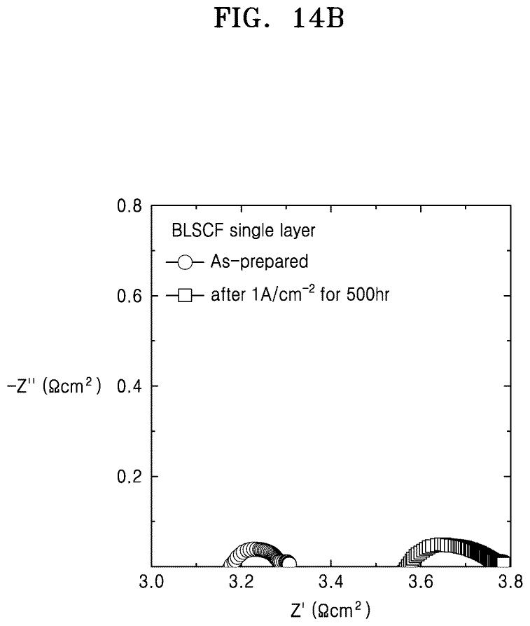

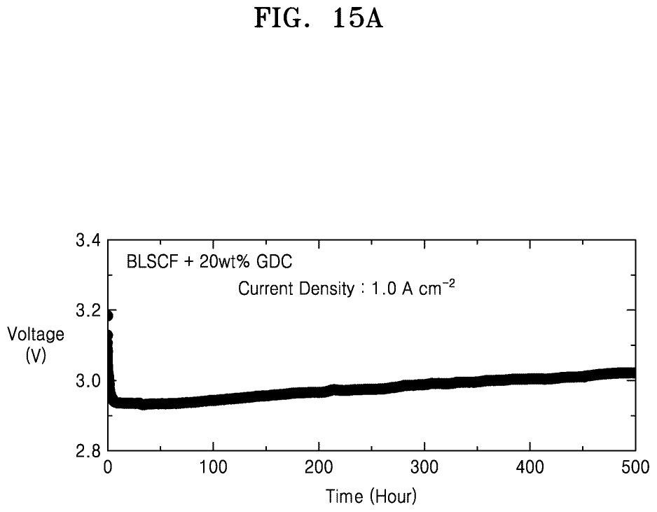

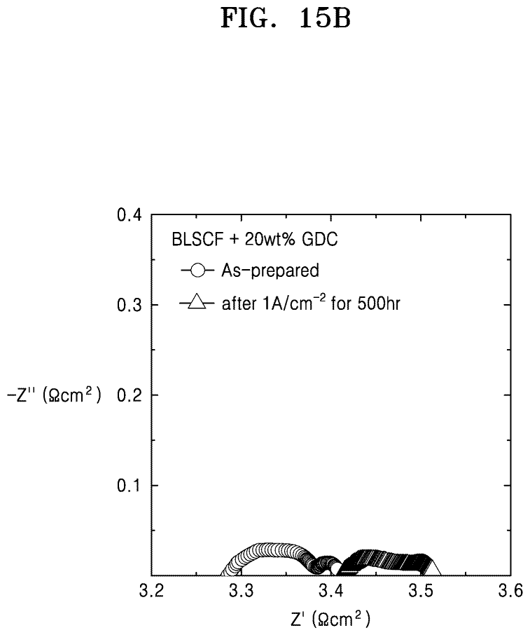

FIG. 14A shows the change in voltage over time for the symmetric cell of Comparative Example 1. FIG. 15A shows the change in voltage over time for the symmetric cell of Example 1.

As shown in FIGS. 14A and 15A, the voltage increase of the symmetric cell of Example 1 after 500 hours was about 0.09 V, showing a reduced increase compared to the about 0.32 V increase for the symmetric cell of Comparative Example 1. It was confirmed that the air electrode of Example 1 provides improved structural stability and lifetime characteristics compared to the air electrode of Comparative Example 1.

For the symmetric cell-type solid oxide cells prepared in Example 1 and Comparative Example 1, impedance was measured respectively before and after a durability evaluation conducted by applying a constant current at a current density of 1.0 A/cm² at 700 °C for 500 hours. The impedance was measured by a 2-probe method using an impedance analyzer (Solartron 1400A/1455A). The frequency range was 0.1 Hz to 1 MHz, and the amplitude voltage was 10 mV.

FIG. 14B shows a Nyquist plot of the impedance measurement results for the symmetric cell of Comparative Example 1. FIG. 15B shows a Nyquist plot of the impedance data for the symmetric cell of Example 1. As shown in FIGS. 14B and 15B, the ohmic resistance (Rₒₕₘ) of the symmetric cell of Example 1 increased from 3.285 Ω·cm² to 3.415 Ω·cm² before and after the 500-hour constant current application, whereas the ohmic resistance of the symmetric cell of Comparative Example 1 increased from 3.1785 Ω·cm² to 3.568 Ω·cm².

The increase in ohmic resistance for the symmetric cell of Example 1 before and after the 500-hour constant current application was reduced compared to that for the symmetric cell of Comparative Example 1. It was confirmed that the air electrode of Example 1 more effectively suppresses the increase in interfacial resistance, for example, the formation of an insulating phase, during the operation of the solid oxide cell compared to the air electrode of Comparative Example 1.

As shown in FIGS. 14B and 15B, the polarization resistance (Rₚₒₗ) of the symmetric cell of Example 1 decreased from 0.0595 Ω·cm² to 0.0485 Ω·cm² before and after the 500-hour constant current application, whereas the polarization resistance of the symmetric cell of Comparative Example 1 increased from 0.065 Ω·cm² to 0.107 Ω·cm².

For the symmetric cell of Example 1, the change (or the increase) in polarization resistance before and after the 500-hour constant current application was suppressed compared to that for the symmetric cell of Comparative Example 1. It was confirmed that the air electrode of Example 1 improves the reversibility of the electrode reaction at the interface, compared with the air electrode of Comparative Example 1.

Evaluation Example 3: Compositional Analysis of Symmetric Cells after Durability Evaluation

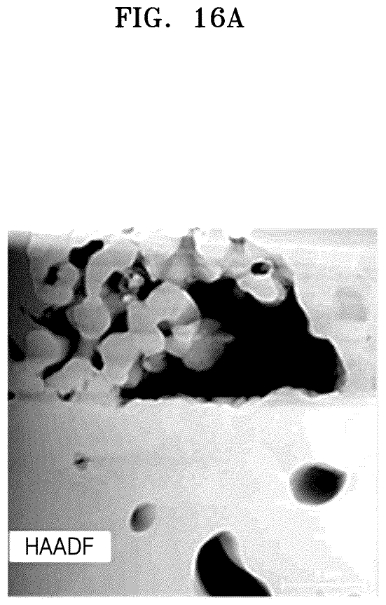

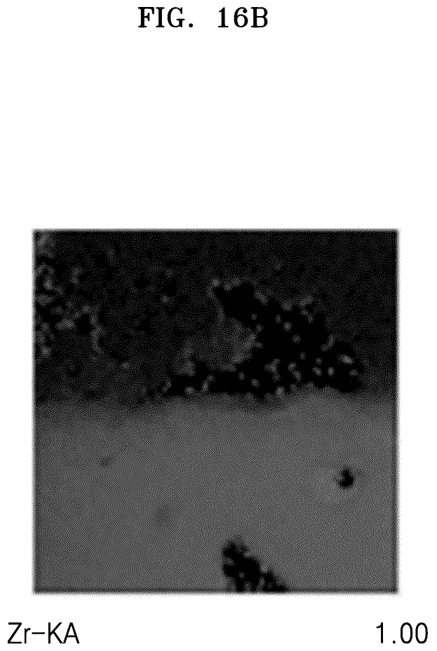

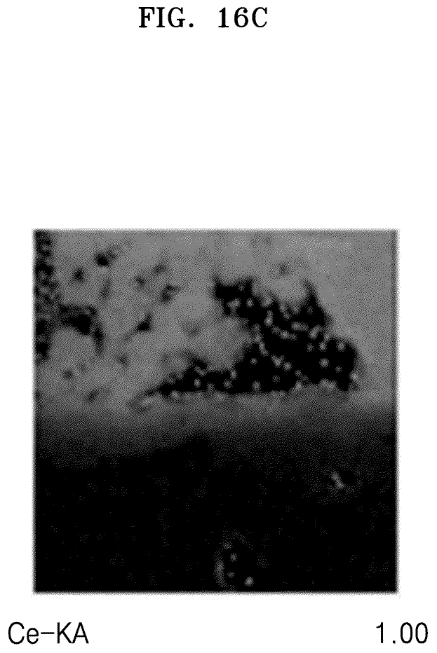

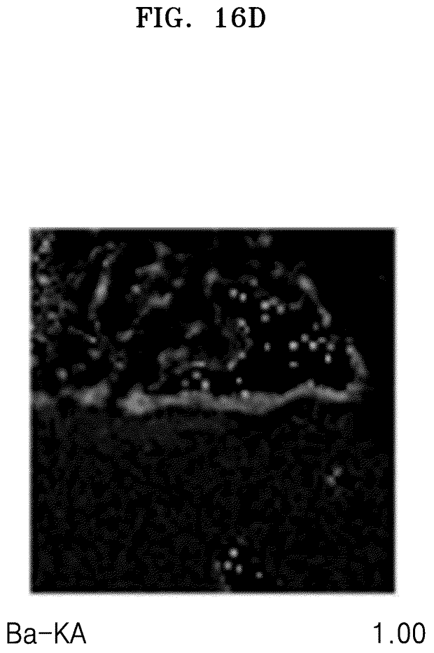

For the symmetric cell of Example 1, high-angle annular dark field image (HAADF) STEM and energy dispersive X-ray spectroscopy (EDS) were performed on a cross-section after applying a constant current for 500 hours as described in Evaluation Example 1, and the measurement results are shown in FIGS. 16A to 16D.

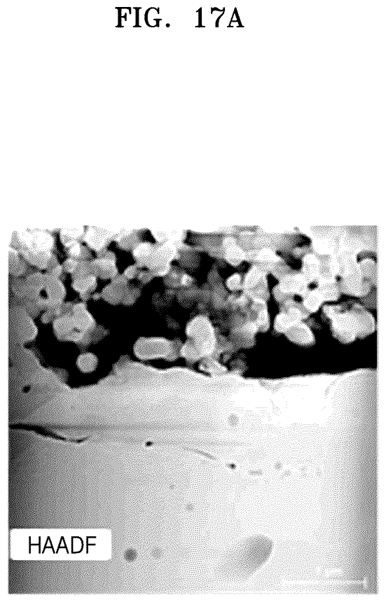

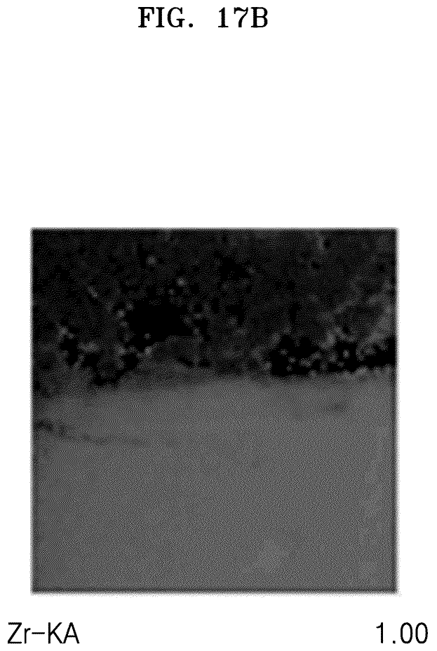

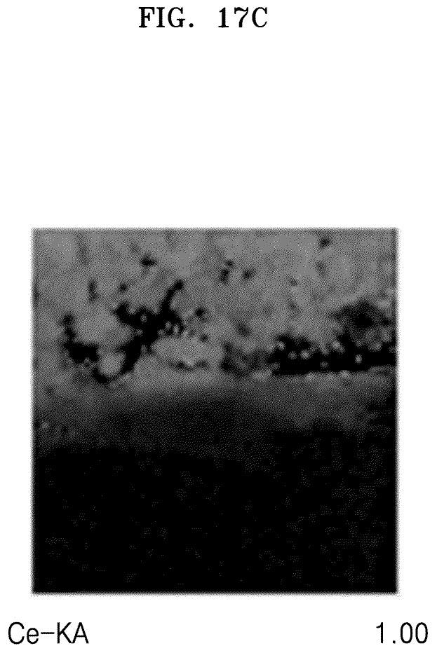

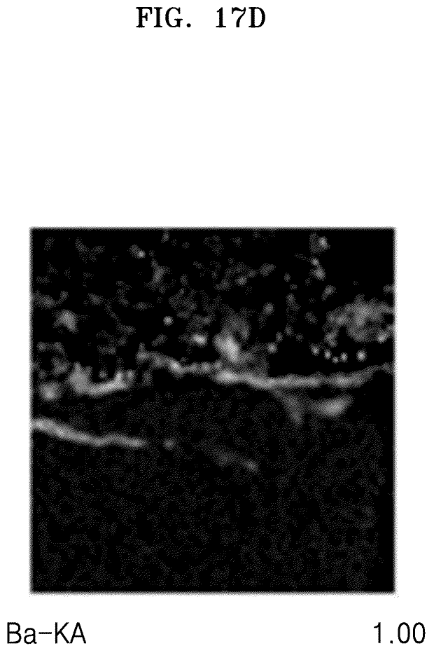

For the symmetric cell of Comparative Example 1, HAADF STEM and EDS were performed on a cross-section after applying a constant current for 500 hours as described in Evaluation Example 1, and the measurement results are shown in FIGS. 17A to 17D.

FIGS. 16A to 16D are HAADF STEM and EDS images of a cross-section between the solid electrolyte layer and the reaction barrier layer in the symmetric cell of Example 1.

FIGS. 17A to 17D are HAADF STEM and EDS images of a cross-section between the solid electrolyte layer and the reaction barrier layer in the symmetric cell of Comparative Example 1. It was confirmed that a Ba-containing layer was disposed on one surface of the solid electrolyte layer adjacent to the reaction barrier layer.

The Ba-containing layer was determined to be an insulating secondary phase of BaZrO₃ having a perovskite-type structure. The Ba content of the Ba-containing layer formed in the symmetric cell of Example 1 after 500 hours of constant current application was lower than the Ba content of the Ba-containing layer formed in the symmetric cell of Comparative Example 1 after 500 hours of constant current application.

It was confirmed that the increase in interfacial resistance between the solid electrolyte layer and the reaction barrier layer in the symmetric cell of Example 1 was suppressed compared to that in the symmetric cell of Comparative Example 1.

In the XPS surface compositional analysis of the symmetric cell of Example 1, the Ba content of the Ba-containing layer was less than 50% of the Ba content of the first electrode layer, whereas in the symmetric cell of Comparative Example 1, the Ba content of the Ba-containing layer was greater than 50% of the Ba content of the first electrode layer.

### Electrode-Solid Electrolyte Assembly and Solid Oxide Cell: Full Cell (Button Cell)) (Simple-Mix Layer=Uniform Composition

Example 2: First Electrode Layer (BLSCF, 20 μm)/Second Electrode Layer (BLSCF+GDC, 5 μm)/Reaction Barrier Layer (GDC)/Solid Electrolyte Layer (YSZ)/Fuel Electrode (Ni+YSZ) Structure, Full Cell

### Preparation of Electrode-Solid Electrolyte Assembly and Solid Oxide Cell

YSZ powder was placed in a pelletizer, pressed using uniaxial pressure, and sintered for 5 hours in an air atmosphere at 1450 °C to prepare a YSZ pellet with a thickness of 0.5 mm. A GDC (Ce_{0.9}Gd_{0.1}O₂, BET: 11.8 m²/g, FCM, USA) paste was coated on one surface of the YSZ pellet by a screen-printing method and sintered for 2 hours in an air atmosphere at 1200 °C to prepare a first laminate having a reaction barrier layer (GDC layer)/solid electrolyte layer (YSZ layer) structure.

NiO powder and YSZ powder were mixed in a weight ratio of 60:40, and ethanol was added to prepare a fuel electrode paste. The fuel electrode paste was coated on the other surface of the YSZ by a screen-printing method and sintered for 2 hours in an air atmosphere at 1000 °C to prepare a second laminate having a reaction barrier layer (GDC layer)/solid electrolyte layer (YSZ layer)/fuel electrode (Ni+YSZ) structure.

The first solid ion conductor powder prepared in Preparation Example 1 was ball-milled to prepare a milled first solid ion conductor powder. The milled first solid ion conductor powder and an ink vehicle solution (FCM) were mixed in a weight ratio of 2:1 to prepare a first solid ion conductor paste. The D50 average particle size of the milled first solid ion conductor (BLSCF) powder was about 1 μm.

A GDC (Ce_{0.9}Gd_{0.1}O₂, BET: 11.8 m²/g, FCM, USA) paste was prepared as a second solid ion conductor paste. The D50 average particle size of the GDC was about 200 nm. The first solid ion conductor paste and the second solid ion conductor paste were mixed to prepare a mixed solid ion conductor paste. In the mixed solid ion conductor paste, 20 parts by weight of the second solid ion conductor were used per 100 parts by weight of the first solid ion conductor. The mixed solid ion conductor paste was coated on the reaction barrier layer of the second laminate by a screen-printing method and sintered for 2 hours in an air atmosphere at 900 °C to prepare a third laminate. The third laminate had a second air electrode layer (BLSCF+GDC)/reaction barrier layer (GDC layer)/solid electrolyte layer (YSZ layer)/fuel electrode (Ni+YSZ) structure. In the third laminate, the thickness of the second air electrode layer was about 5 μm.

The first solid ion conductor paste was coated on the second air electrode layer of the third laminate by a screen-printing method and sintered for 2 hours in an air atmosphere at 900 °C to prepare a fourth laminate. The fourth laminate had a first air electrode layer (BLSCF)/second air electrode layer (BLSCF+GDC)/reaction barrier layer (GDC layer)/solid electrolyte layer (YSZ layer)/fuel electrode (Ni+YSZ) structure. In the fourth laminate, the thickness of the first air electrode layer was about 20 μm.

An Ag paste (H4580, Shoei Chemical, Japan) was coated on the air electrode and fuel electrode of the fourth laminate, and then an Ag mesh and wire were connected to prepare a solid oxide full cell.

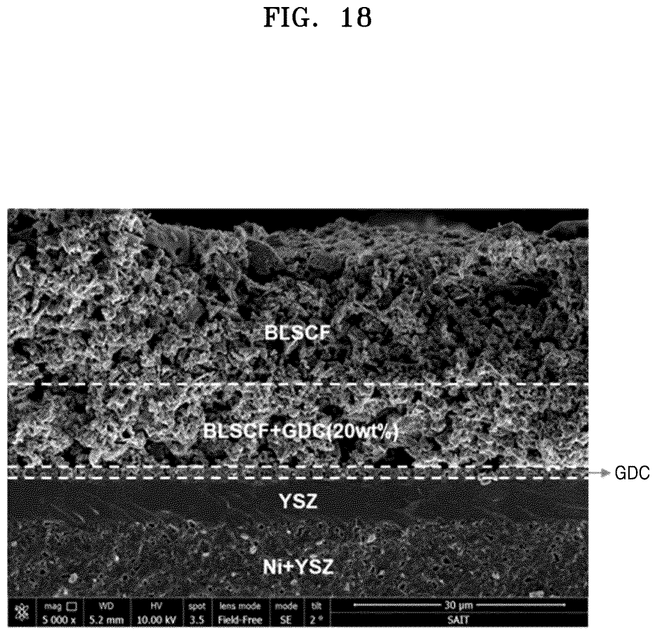

FIG. 18 shows a scanning electron microscope image of a cross-section of the full cell prepared in Example 2.

Example 3: First Electrode Layer (BLSCF, 20 μm)/Second Electrode Layer (BLSCF+GDC, 10 μm)/Reaction Barrier Layer (GDC)/Solid Electrolyte Layer (YSZ)/Fuel Electrode (Ni+YSZ) Structure, Full Cell

An electrode-solid electrolyte assembly and a metal oxide cell were prepared in the same manner as in Example 2, except that the thickness of the second air electrode layer was changed to 10 μm.

Example 4: First Electrode Layer (BLSCF, 20 μm)/Second Electrode Layer (BLSCF+GDC, 20 μm)/Reaction Barrier Layer (GDC)/Solid Electrolyte Layer (YSZ)/Fuel Electrode (Ni+YSZ) Structure, Full Cell

An electrode-solid electrolyte assembly and a metal oxide cell were prepared in the same manner as in Example 2, except that the thickness of the second air electrode layer was changed to 20 μm.

### Evaluation Example 4: Durability Evaluation of Full Cell

For the full cell-type solid oxide cell prepared in Example 2, a constant current was applied at a current density of 0.5 A·cm² at 700 °C for 180 hours, and the change in voltage over time was measured.

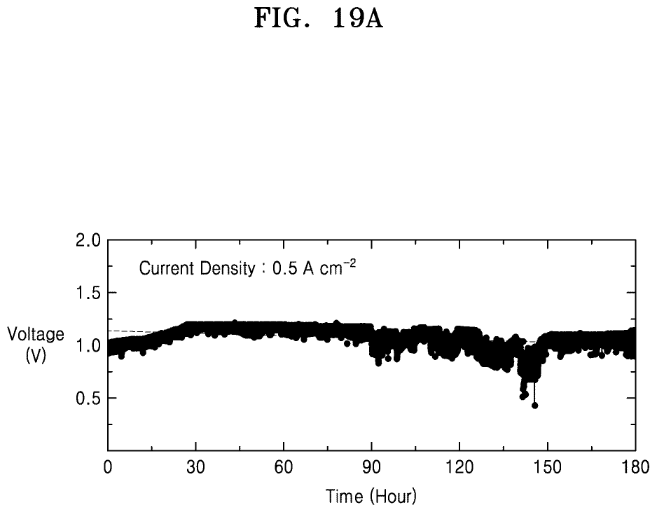

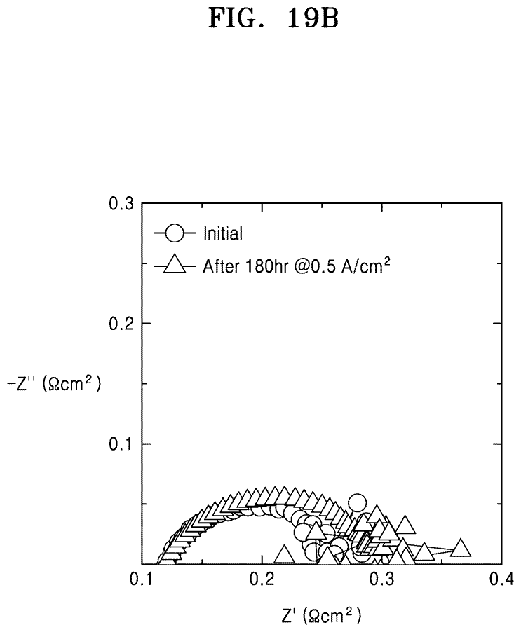

During the application of constant current to the full cell-type solid oxide cell, air was supplied to one air electrode (first electrode layer/second electrode layer) at a flow rate of 400 sccm, and H₂O/H₂ (80% H₂O in H₂) was supplied at the fuel electrode at a flow rate of 200 sccm. The change in voltage over time for the full cell of Example 2 is shown in FIG. 19A. As shown in FIG. 19A, the voltage of the full cell of Example 2 increased for up to 30 hours, and then the cell maintained a stable voltage while operating stably for up to 180 hours.

For the full cell-type solid oxide cell prepared in Example 2, impedance was measured respectively before and after a durability evaluation conducted by applying a constant current at a current density of 0.5 A/cm² at 700 °C for 180 hours. The impedance was measured by a 2-probe method using an impedance analyzer (Solartron 1400A/1455A). The frequency range was 0.1 Hz to 1 MHz, and the amplitude voltage was 10 mV. FIG. 19B shows a Nyquist plot of the impedance measurement results for the full cell of Example 2.

As shown in FIG. 19B, for the full cell of Example 2, the change in ohmic resistance (Rₒₕₘ) and polarization resistance (Rₚₒₗ) before and after the 180-hour constant current application was reduced and fell within the measurement's margin of error. It was confirmed that the solid oxide cell of Example 2 has excellent structural stability and durability.

### Evaluation Example 5: Performance Evaluation of Full Cell

For the full cell-type solid oxide cells prepared in Examples 2 to 4, the performance was evaluated at 700 °C.

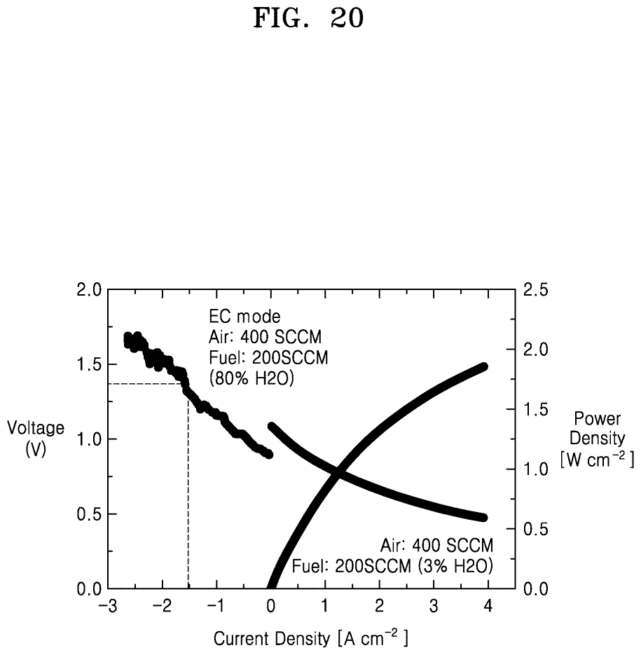

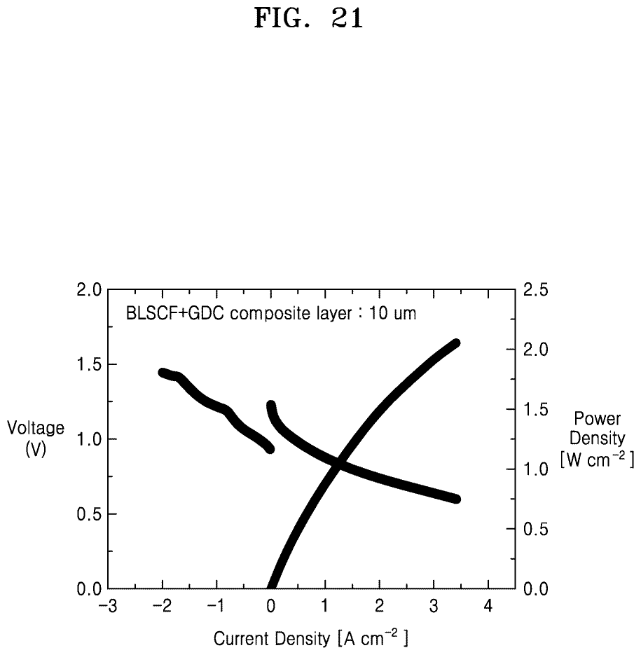

The evaluation results for Examples 2 and 3 are shown in FIGS. 20 and 21, respectively.

In EC (Electrolysis Cell) mode, the current was measured while changing the voltage. In EC mode, air was supplied to the air electrode (first electrode layer/second electrode layer) at a flow rate of 400 sccm, and H₂O/H₂ (80% H₂O in H₂) was supplied at the fuel electrode at a flow rate of 200 sccm. In FC (Fuel Cell) mode, the voltage and power density were measured while changing the current. In FC mode, air was supplied to the air electrode (first electrode layer/second electrode layer) at a flow rate of 400 sccm, and H₂O/H₂ (3% H₂O in H₂) was supplied at the fuel electrode at a flow rate of 200 sccm.

The initial performance evaluation results in EC mode are shown in Table 1.

TABLE 1

| | Second | First | Initial EC-mode |
|---|---|---|---|
| | electrode layer | electrode layer | performance |
| | [μm] | [μm] | [A/cm², 1.3 V, 700 °C] |
| Example 2 | 5 | 20 | 1.5 |
| Example 3 | 10 | 20 | 1.5 |
| Example 4 | 20 | 20 | 1.053 |

As shown in Table 1, the solid oxide cells of Examples 2 to 4 exhibited favorable current densities in EC mode.

Compared to the solid oxide cell of Example 4, the solid oxide cells of Examples 2 and 3 exhibited improved current densities at the thermal neutral voltage (1.3 V).

Compared to the solid oxide cell of Example 4, the solid oxide cells of Examples 2 and 3 showed an increased content of produced hydrogen and oxygen, indicating that the efficiency of the electrolysis reaction was increased.

### Electrode-Solid Electrolyte Assembly and Solid Oxide Cell: Symmetric Cell) (Infiltration Layer=Graded Composition

Example 5: First Electrode Layer (BLSCF, 20 μm)/Second Electrode Layer (BLSCF+GDC, 13 μm)/Reaction Barrier Layer (GDC)/Solid Electrolyte Layer (YSZ)/Reaction Barrier Layer (GDC)/Second Electrode Layer (BLSCF+GDC, 13 μm)/First Electrode Layer (BLSCF, 20 μm) Structure, Symmetric Cell

### Preparation of Electrode-Solid Electrolyte Assembly and Solid Oxide Cell

YSZ powder was placed in a pelletizer, pressed using uniaxial pressure, and sintered for 5 hours in an air atmosphere at 1450 °C to prepare a YSZ pellet with a thickness of 0.5 mm. A GDC (Ce_{0.9}Gd_{0.1}O₂, BET: 11.8 m²/g, FCM, USA) paste was coated on both surfaces of the YSZ pellet by a screen-printing method and sintered for 2 hours in an air atmosphere at 1200 °C to prepare a first laminate having a reaction barrier layer (GDC layer)/solid electrolyte layer (YSZ layer)/reaction barrier layer (GDC layer) structure.

The first solid ion conductor powder prepared in Preparation Example 1 was ball-milled to prepare a milled first solid ion conductor powder. The milled first solid ion conductor powder and an ink vehicle solution (FCM) were mixed in a weight ratio of 2:1 to prepare a first solid ion conductor paste. The D50 average particle size of the milled first solid ion conductor (BLSCF) powder was about 1 μm.

GDC (Ce_{0.9}Gd_{0.1}O₂) powder with a D50 average particle size of about 50 nm was mixed with ethanol to prepare an infiltration solution containing a second solid ion conductor. The first solid ion conductor paste was coated on the reaction barrier layers on both surfaces of the first laminate by a screen-printing method and calcined for 2 hours in an air atmosphere at 700 °C to form a porous layer on each of the reaction barrier layers (GDC layers).

The infiltration solution was sequentially applied to the porous layers on both surfaces using a pipette to infiltrate the second solid ion conductor particles into the porous layers, and after drying, the assembly was calcined for 2 hours in an air atmosphere at 900 °C to prepare a second laminate. The second laminate had a second air electrode layer (BLSCF+GDC)/reaction barrier layer (GDC layer)/solid electrolyte layer (YSZ layer)/reaction barrier layer (GDC layer)/second air electrode layer (BLSCF+GDC) structure. In the second laminate, the thickness of the second air electrode layer was about 13 μm on each side.

The first solid ion conductor paste was coated on each of the second air electrode layers of the second laminate by a screen-printing method and sintered for 2 hours in an air atmosphere at 700 °C to prepare a third laminate. The third laminate had a first air electrode layer (BLSCF)/second air electrode layer (BLSCF+GDC)/reaction barrier layer (GDC layer)/solid electrolyte layer (YSZ layer)/reaction barrier layer (GDC layer)/second air electrode layer (BLSCF+GDC)/first air electrode layer (BLSCF) structure. In the third laminate, the thickness of the first air electrode layer was about 20 μm on each side.

An Ag paste (H4580, Shoei Chemical, Japan) was coated on each of the air electrodes on both surfaces of the third laminate, and then an Ag mesh and wire were connected to prepare a solid oxide symmetric cell.

### Evaluation Example 6: Evaluation of Scanning Electron Microscope Image

For a cross-section of the second air electrode layer prepared during the manufacturing process of the symmetric cell of Example 5, scanning electron microscopy was performed to evaluate the distribution of the second solid ion conductor infiltrated into the second air electrode layer along the thickness direction. Scanning electron microscope images of a cross-section of the second air electrode layer prepared during the manufacturing process of the symmetric cell of Example 5 are shown in FIGS. 4A to 4D.

FIG. 4A is a scanning electron microscope image of a cross-section of the second air electrode layer of the symmetric cell prepared in Example 5.

FIG. 4B is a scanning electron microscope image of a cross-section of the upper region (the first region, a region within 5% of the thickness from the top surface) of the second air electrode layer shown in FIG. 4A.

FIG. 4C is a scanning electron microscope image of a cross-section of the middle region of the second air electrode layer shown in FIG. 4A.

FIG. 4D is a scanning electron microscope image of a cross-section of the lower region (the second region, a region within 5% of the thickness from the bottom surface) of the second air electrode layer shown in FIG. 4A.

As shown in FIG. 4B, in the upper region of the second air electrode layer, most of the first solid ion conductor particles forming the scaffold were not coated by the second solid electrolyte particles. In FIG. 4B, the area of the region containing the second solid electrolyte was 10% or less of the total area.

As shown in FIG. 4C, in the middle region of the second air electrode layer, some of the first solid ion conductor particles forming the scaffold were not coated by the second solid electrolyte particles. In FIG. 4C, the area of the region containing the second solid electrolyte was 30% or less of the total area.

As shown in FIG. 4D, in the lower region of the second air electrode layer, most of the first solid ion conductor particles forming the scaffold were coated by the second solid electrolyte particles. In FIG. 4D, the area of the region containing the second solid electrolyte was 70% or more of the total area.

It was confirmed that the second air electrode layer has a low content of the second solid ion conductor in the upper region and a high content of the second solid ion conductor in the lower region, and the second air electrode layer has a gradient in which the content of the second solid ion conductor transitions from a low content to a high content from the upper region to the lower region.

### Evaluation Example 7: Durability Evaluation of Symmetric Cell

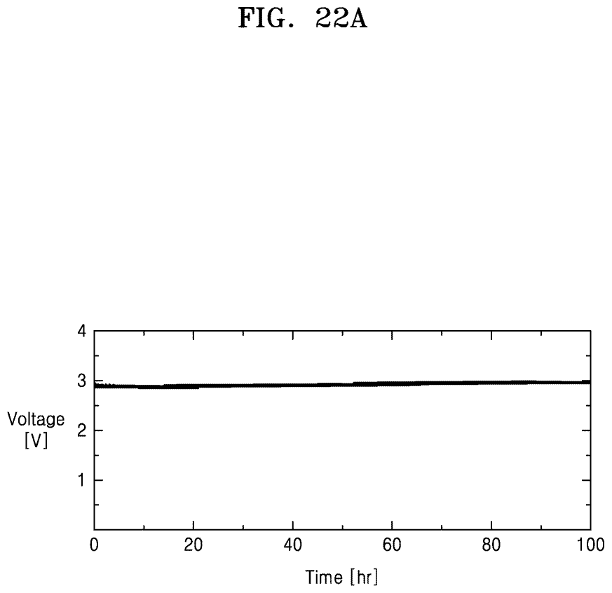

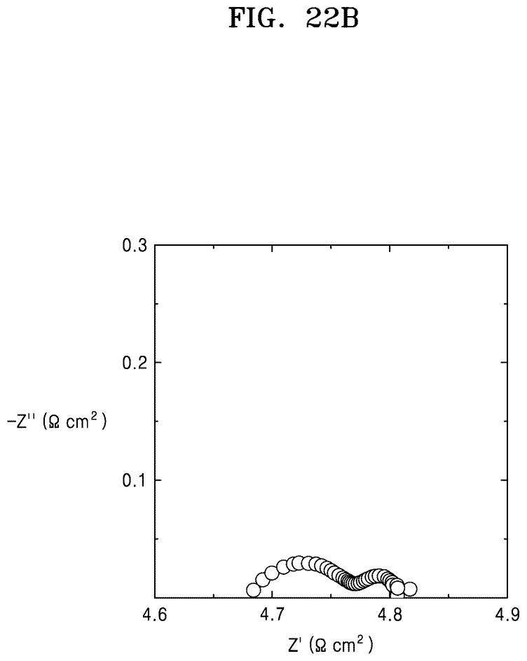

For the symmetric cell prepared in Example 5, a constant current was applied at a current density of 1.0 A/cm² at 700 °C for 500 hours, and the change in voltage over time was measured. FIG. 22A shows the change in voltage over time for the symmetric cell of Example 5. As shown in FIG. 22A, the voltage increase after 100 hours for Example 5 was about 0.1 V, indicating that the voltage increase was minimal. It was confirmed that the air electrode of Example 5 provides excellent structural stability and lifetime characteristics.

For the symmetric cell prepared in Example 5, impedance was measured respectively before and after a durability evaluation conducted by applying a constant current at a current density of 0.5 A/cm² at 700 °C for 180 hours. The impedance was measured by a 2-probe method using an impedance analyzer (Solartron 1400A/1455A). The frequency range was 0.1 Hz to 1 MHz, and the amplitude voltage was 10 mV.

FIG. 22B shows a Nyquist plot of the impedance measurement results for the symmetric cell of Example 5. As shown in FIG. 22B, the symmetric cell of Example 5 exhibited a polarization resistance of about 0.1 Ω·cm² before the application of the constant current. It was confirmed that the symmetric cell of Example 5 has excellent structural stability and durability.

Various modifications may be made within the scope of the appended claims, the detailed description, and the accompanying drawings, and such modifications are also encompassed within the scope of the present disclosure.

According to one aspect, provided is a novel electrode-solid electrolyte assembly having improved structural stability and electrolysis performance.

According to another aspect, provided is a solid oxide cell having improved structural stability and electrolysis performance.

According to one aspect, provided is a method of preparing a novel electrode-solid electrolyte assembly for a solid oxide cell having improved structural stability and electrolysis performance.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. An electrode-solid electrolyte assembly comprising an electrode and a solid electrolyte layer, the electrode comprising:
a first electrode layer including a first solid ion conductor; and
a second electrode layer disposed between the first electrode layer and a surface of the solid electrolyte layer, and including the first solid ion conductor and a second solid ion conductor,
wherein the first solid ion conductor includes a metal oxide having a perovskite-type structure comprising a first element and a second element that occupy cuboctahedral sites of the perovskite-type structure, and the first element and the second element are each independently an element belonging to Group 2 of the periodic table and having an atomic weight of 30 or more, and
wherein the second electrode layer has a content gradient in which a content of the second solid ion conductor transitions from a first content in a first region adjacent to the first electrode layer to a second content in a second region adjacent to the solid electrolyte layer, and
the second content is greater than the first content, or
the first content of the second solid ion conductor is essentially constant from the first region to the second region of the second electrode layer.

2. The electrode-solid electrolyte assembly of claim 1,
wherein the metal oxide further comprises a third element that occupies a cuboctahedral site, and
the second electrode layer has the content gradient, which comprises a continuous transitioning gradient, a stepwise transitioning gradient, or a combination thereof.

3. The electrode-solid electrolyte assembly of claim 1,
wherein a ratio T1/T2 of a thickness T1 of the first electrode layer to a thickness T2 of the second electrode layer is 1.1 or greater.

4. The electrode-solid electrolyte assembly of claim 1,
wherein a thickness T1 of the first electrode layer is about 5 μm to about 100 μm, and
a thickness T2 of the second electrode layer is about 1 μm to about 15 μm.

5. The electrode-solid electrolyte assembly of claim 1,
wherein the second electrode layer has the content gradient, which is defined by a ratio A1/A2 of a first content A1 of the second solid ion conductor in the first region to a second content A2 of the second solid ion conductor in the second region is 0.5 or less.

6. The electrode-solid electrolyte assembly of claim 1,
wherein the first region includes a structural framework comprising the first solid ion conductor, and
the second solid ion conductor contacts at least a portion of the structural framework to provide a first-1 region, and a remaining portion of the second solid ion conductor is not in contact with the structural framework, and
wherein a ratio S1-1/S1-2 of an area S1-1 of the first-1 region to an area S1-2 of the first-2 region is less than 1.

7. The electrode-solid electrolyte assembly of claim 1,
wherein the second region includes:
a structural framework comprising the first solid ion conductor, and the second solid ion conductor is in contact with at least a portion of the structural framework; and
a second-1 region in which the second solid ion conductor is not in contact with the structural framework, and
wherein a ratio S2-1/S2-2 of an area S2-1 of the second-1 region to an area S2-2 of the second-2 region is more than 1.

8. The electrode-solid electrolyte assembly of claim 1,
wherein the content of the second solid ion conductor in the second electrode layer is 30 wt % or less, based on a total weight content of the first solid ion conductor and the second solid ion conductor.

9. The electrode-solid electrolyte assembly of claim 1,
wherein the first solid ion conductor includes first particles, and the second solid ion conductor includes second particles, and
a particle diameter D1 of the first particles is greater than a particle diameter D2 of the second particles, and
a ratio D2/D1 of the particle diameter D2 to the particle diameter D1 is 0.2 or less.

10. The electrode-solid electrolyte assembly of claim 9,
wherein the particle diameter D1 of the first particles is about 500 nanometers to about 5 micrometers, and
the particle diameter D2 of the second particles is about 10 nanometers to about 400 nanometers.

11. The electrode-solid electrolyte assembly of claim 9,
wherein an aspect ratio of the first particles is 2 or more, and
an aspect ratio of the second particles is 2 or more.

12. The electrode-solid electrolyte assembly of claim 9,
wherein the second electrode layer includes first pores P1 defined by an aggregate of adjacent first particles and second pores P2 defined by an aggregate of adjacent second particles, and
a first pore size PD1 is greater than a second pore size PD2, and
a ratio PD2/PD1 is 0.5 or less.

13. The electrode-solid electrolyte assembly of claim 1,
further comprising a reaction barrier layer between the second electrode layer and the solid electrolyte layer,
wherein the reaction barrier layer includes the second solid ion conductor and not the first solid ion conductor.

14. The electrode-solid electrolyte assembly of claim 1,
wherein the solid electrolyte layer includes an interlayer on a surface adjacent to the second electrode layer,
wherein the interlayer includes a metal oxide, the metal oxide including: the first element or the second element; and a seventh element,
wherein the seventh element includes one or more transition metals belonging to Groups 3 to 12 of the periodic table.

15. The electrode-solid electrolyte assembly of claim 14,
wherein
a ratio B1/B2 of a content B1 of the first element in the interlayer to a content B2 of the first element in the first electrode layer is 0.5 or less, as determined by XPS analysis of the electrode-solid electrolyte assembly including the interlayer.

16. The electrode-solid electrolyte assembly of claim 1,
wherein the metal oxide includes a first element, a second element and a third element, each of which occupies cuboctahedral sites of the perovskite-type structure, and
the metal oxide further includes a fourth element and a fifth element, and optionally a sixth element, each or which occupies octahedral sites of the perovskite-type structure,
wherein the third element is an element belonging to Group 3 of the periodic table, and has a smaller ionic radius than the first element and/or the second element,
the fourth element and the fifth element are each an element belonging to Groups 8 to 11 of the periodic table, and
the sixth element is an element belonging to Group 3, Group 4, or Groups 7 to 12 of the periodic table,
wherein a molar content of each of the first element, the second element, or the third element is 0.5 or less based on a total mole content of the first, second, and third elements.

17. The electrode-solid electrolyte assembly of claim 1,
wherein the metal oxide having the perovskite-type structure is represented by Formula 1:
M3ₐ₁M1_{b1}M2_{c1}M4_{d1}M5ₑ₁M6_{f1}O_{3-δ} Formula 1
wherein, in Formula 1,
0.01≤a1≤0.5, 0.01≤b1≤0.5, 0.01≤c1≤0.5, 0.1≤d1≤0.9, 0.1≤e1≤0.9, 0≤f1<0.2, and 0≤δ<1,
M3 is an element belonging to Group 3 of the periodic table,
M1 and M2 are the first element and the second element, respectively,
M4 and M5 are each independently an element belonging to Groups 8 to 11 of the periodic table,
M6 is an element belonging to Group 3, Group 4, or Groups 7 to 12 of the periodic table, and
δ is an oxygen vacancy.

18. The electrode-solid electrolyte assembly of claim 1,
wherein the metal oxide having the perovskite-type structure is represented by Formula 2:
Laₐ₂Sr_{b2}Ba_{c2}M4_{d2}M5ₑ₂M6_{f2}O_{3-δ} Formula 2
wherein, in Formula 2,
0.01≤a2≤0.5, 0.01≤b2≤0.5, 0.01≤c2≤0.5, 0.1≤d2≤0.9, 0.1≤e2≤0.9, 0≤f2<0.2, and 0≤δ<1;
M4 and M5 are each independently an element belonging to Groups 8 to 11 of the periodic table;
M6 is an element belonging to Group 3, Group 4, or Groups 7 to 12 of the periodic table and, when M6 is a Group 3 element, M6 is an element having an atomic weight of 150 or more, and
δ is an oxygen vacancy.

19. A solid oxide cell comprising:
the electrode-solid electrolyte assembly according to claim 1; and
a fuel electrode disposed on an opposite surface of the solid electrolyte layer of the assembly,
wherein the electrode of the assembly is an air electrode.

20. A method of preparing an electrode-solid electrolyte assembly, the method comprising:
providing a solid electrolyte layer;
providing a second electrode layer precursor including a first solid ion conductor on a surface of the solid electrolyte layer;
infiltrating the second electrode layer precursor with a composition including second solid ion conductor particles and a solvent, to provide a second electrode layer precursor including second solid ion conductor particles;
heat-treating the second electrode layer precursor including the second solid ion conductor particles to provide a second electrode layer; and
positioning a first electrode layer on the second electrode layer to provide the electrode-solid electrolyte assembly,
wherein the second electrode layer has a content gradient that transitions from a first content of the second solid ion conductor in a first region adjacent to the first electrode layer to a second content of the second solid ion conductor in a second region adjacent to the solid electrolyte layer, and
the second content is greater than the first content, or
the first content of the second solid ion conductor is essentially constant from the first region to the second region of the second electrode layer,
wherein the first solid ion conductor includes a metal oxide having a perovskite-type structure comprising a first element and a second element that occupy cuboctahedral sites of the perovskite-type structure, and the first element and the second element are each independently an element belonging to Group 2 of the periodic table and having an atomic weight of 30 or more.
